(19) United States
(12) Patent Application Publication
(10) Pub. No.: US 2006/0253290 A1
(43) Pub. Date: Nov. 9, 2006

(54) Electronic commerce system and method thereof

(76) Inventor: Sun-Tae Kwon, Seoul (KR)

Correspondence Address: BIRCH STEWART KOLASCH & BIRCH, PO BOX 747, FALLS CHURCH, VA, 22040-0747, US

(21) Appl. No.: 10/556,580

(22) PCT Filed: May 13, 2004
(86) PCT No.: PCT/KR04/01109

§ 371 Date: Nov. 14, 2005

(30) Foreign Application Priority Data
May 13, 2003 (KR) 1020030030064

(51) Int. Cl. G06Q 99/00

(52) U.S. Cl. 705/1

(57) ABSTRACT

Disclosed are an electronic commerce system utilizing a specific terminal number, a digital camera and an item specific code, and the method thereof. In this invention, data transmission between terminals or between a terminal and a server is carried out by a wireless transmission module such as RF, infrared, ultrasonic wave. In the data transmission, the item specific code is included in the processed data and is used to identify the data users and utilize in the electronic commerce system.

### TECHNICAL FIELD

The present invention relates to an electronic commerce system and method thereof adopting an item specific code, particularly to an electronic commerce system and method thereof which utilize a user identifying technique in which the data demanding entity is determined by processed data including specific code data of a terminal or a server in transmission of data between terminals having wireless transmission module.

Further, the present invention relates to an electronic commerce system and method thereof utilizing the item specific code in which a tag containing information on the item specific code is attached to a product which has been purchased by a member, and then when a purchaser buys the product by using the terminal specific number or the item specific code, some portion of profit over the transaction is allotted to the member.

### BACKGROUND ART

In recent years, electronic commerce is booming owing to wide spread of the Internet. In conventional electronic commerce system, commercial transaction is generally performed in a manner that a user connects to a server, which is provided by a seller and can be accessed through the Internet, by using a terminal such as personal computer (PC); searches categorized item list; decides to purchase a certain item; places an order; and pays for the selected item, then the item is delivered to the purchaser.

However, one of problems in such electronic commerce system is that a purchaser cannot directly see and confirm the actual object of the item which he/she wishes to have, thereby the purchaser's interest to buy is likely to be reduced, further when a purchaser has seen the actual object of item in everyday life beforehand, and wishes to buy the item through an electronic commerce system, the user would spend long time with efforts on searching for the same or equivalent item. Especially, in case of clothes or accessories, customers generally tend to avoid purchasing without directly seeing the actual object, thereby electronic commerce related with such item is not in great progress.

An invention has been designed to overcome above problems by the same inventors of the present invention and filed on Sep. 19, 2002 that is Korean Patent application No. 2002-57427. It discloses a novel electronic commerce system and method thereof, in which, a tag containing information on the item specific code is attached to the corresponding item, therefore a purchaser can conveniently search for the same item by using the information in the tag. In the invention, when a purchaser searches for and purchases the same item which was purchased by a member, by using the item specific code attached to the item, a certain portion of profit from the transaction is allotted to the member.

FIG. 1 is a schematic configuration diagram, which roughly illustrates the conventional electronic commerce system which has been mentioned above, and FIG. 2 is a flow chart which shows the method.

As illustrated in FIG. 1, one embodiment of the electronic commerce system according to the invention is comprised of: an electronic commercial transaction server (10); a database (15); a personal computer (22) or mobile communication terminal (24) by which a purchaser (20) can connect to the electronic commercial transaction server (10); a tag (50) containing information on the item specific code which is attached to the corresponding item; a code reader (40) for reading in the item specific code in the tag (50); a digital camera (60) for taking a picture of a member's appearance for example, face, and a supplier (70), a delivery agency (72) and a financial institution (74) which are associated with the electronic commercial transaction server (10).

A member connects to the electronic commercial transaction server (10) through a personal computer (30), then searches a list of items and purchases an item. Once the member purchases the item, the electronic commercial transaction server (10) produces an item specific code for the purchased item and reports it with order information to the supplier. Then, the supplier provides the ordered item with a tag (50) in the form of, for instance, a label (52) or an integrated circuit chip (54), which contains the item specific code information and is attached to or installed in the item, and the item is delivered to the member via a delivery agency. In the transaction process, information on the item specific code, the purchased item and the member is saved to the database (15) of the electronic commercial transaction server (10). In the database (15), for one member, information on the list of items which were purchased by the certain member is stored and registered so that any purchaser can collectively search for the whole registered items of the member. When the purchaser places an order and pays for one of the registered items of the member, i.e. the first purchaser of the item, the electronic commercial transaction server (10) allots a certain portion of the payment to the member.

In the above invention, the member who first purchased the corresponding item is served as a kind of an advertising model, and receives a portion of the payment by other purchaser, in reward of opening his/her information to the public.

Meanwhile, in the invention, information on the item specific code contained in the item tag in the form of a number, a label or an integrated circuit chip as well as information on the member who already purchased the item should be transmitted always via the electronic commercial transaction server. In other words, a purchaser receives the information on the item and former member, not directly from the former member, but from the electronic commercial transaction server only after reading in the information contained in the item tag by using a code reader.

In this case, the purchaser should not only read the tag of the item which was purchased by the former member but also connect to the electronic commercial transaction server, therefore it causes great inconvenience to the purchaser. Further, even if a purchaser (a second member) only wishes to search for an item which was purchased by the first member without purchasing it, the purchaser should make a connection to the electronic commercial transaction server inconveniently, and the same may be sequentially applied to another purchaser (a third member).

Therefore, unlikely the above invention where all the members or purchasers should receive the item specific code and other information from the electronic commercial transaction server, such information concerning a certain item needs to be delivered to users in the middle of the whole transactions without connecting to the electronic commercial transaction server, while only the first and the last purchaser are connected to the server. In addition, concerning when there are users who only search for an item without purchasing it, it is necessary to make the later user unable to place an order or the non-purchasing users unable to receive allotment.

### DISCLOSURE OF THE INVENTION

With a purpose to overcome the problems of prior arts, the present invention is to provide an electronic commerce system and method in which members in the middle of the whole transactions (excluding the first and the last purchaser) can obtain information on the item and the former purchaser(s) who had already purchased the item, without connecting to an electronic commerce transaction server.

Thus, the object of the invention is to provide a data transmit-receive method between wireless terminals being applicable to an electronic commerce system, in which the data transmission is carried out between wireless terminals having a wireless transmission module including RF, infrared and ultrasonic wave, without using conventional wireless communication network, or directly between the wireless terminal and the electronic commercial transaction server; and the data demanding entity is identified by a processed data format which includes specific code data of the wireless terminal or server in transmission of the data.

Another object of the invention is to provide a method in which when a member who has transmitted information on a certain item and him/herself to other purchaser did not purchase but only searched for the item, the later purchaser is unable to place an order for the item, or even if the later purchaser can place an order for the item, certain portion of the payment for the above-mentioned member who did not purchase the item is not allotted.

Still, another object of the invention is to provide a method in which a service provider who owns/operates an electronic commercial transaction server can save cost for advertising the item; a member who had already purchased the item can obtain profits in reward of sharing his/her information as an advertising model; and a new purchaser who intends to obtain item information can conveniently place an order after confirming how the item is used by other purchaser as well as obtain information which helps shopping by referring to the purchase tendency of a certain member as a model.

### BRIEF DESCRIPTION OF DRAWINGS

FIG. 1 is a schematic configuration diagram which roughly illustrates the conventional electronic commerce system,

FIG. 2 is a flow chart which shows the outline of the conventional electronic commerce operation,

FIG. 3 is a schematic configuration diagram which roughly illustrates the electronic commerce system according to the present invention,

FIG. 4 is a block diagram which roughly illustrates the configuration of the electronic commerce system and method of one embodiment according to the present invention,

FIG. 5 is a block diagram which roughly illustrates the configuration of the electronic commerce system and method of other embodiment according to the present invention,

FIG. 6 is a block diagram which roughly illustrates the configuration of the electronic commerce system and method of other embodiment according to the present invention,

FIG. 7 is an exemplary scheme of a tag attached to an item according to the present invention,

FIG. 8 is an exemplary scheme of a wired or wireless terminal according to the present invention,

FIG. 9 is a flow chart which illustrates one embodiment of the method of electronic commerce according the present invention,

FIG. 10 is a flow chart which illustrates other embodiment of the method of electronic commerce according to the present invention,

FIG. 11 is a concept diagram which represents the data transmit-receive between wireless terminals according to the present invention,

FIG. 12a is a block diagram which shows the control circuit of a wireless terminal adopting a RF module of Example 1 according to the present invention,

FIG. 12b is a scheme which roughly illustrates the wireless data receiving device of the wireless terminal adopting the RF module according to the present invention,

FIG. 12c is a scheme which roughly illustrates the wireless data transmission device of the wireless terminal adopting the RF module according to the present invention,

FIG. 13a is a block diagram which shows the control circuit of a wireless terminal adopting an infrared module of Example 2 according to the present invention,

FIG. 13b is a scheme which roughly illustrates the wireless data receiving device of the wireless terminal adopting the infrared module according to the present invention,

FIG. 13c is a scheme which roughly illustrates the wireless data transmission device of the wireless terminal adopting the infrared module according to the present invention,

FIG. 14a is a block diagram which shows the control circuit of a wireless terminal adopting an ultrasonic module of Example 3 according to the present invention,

FIG. 14b is a scheme which roughly illustrates the wireless data receiving device of the wireless terminal adopting the ultrasonic module according to the present invention,

FIG. 14c is a scheme which roughly illustrates the wireless data transmission device of the wireless terminal adopting the ultrasonic module according to the present invention,

FIG. 15 is a block diagram which shows the control circuit of an electronic commercial transaction server according to the present invention.

### EXPLANATION OF NUMBERS USED IN THE DRAWINGS

201: a first terminal
202: a second terminal
203: a third terminal
10: a server

### BEST MODE FOR CARRYING OUT THE INVENTION

Accordingly, in order to achieve foregoing objects, the electronic commerce system of the present invention comprises:
1) firstly, an element that a plurality of terminals have their own specific numbers, then information which is stored in each of the plurality of terminals can be transmitted through the terminal specific number,
2) secondly, an element that coordination can be made by using digital pictures of other member or him/herself, with a specific item, who had already purchased the item,
3) thirdly, an element that information on the item which had been purchased by a member can be transmitted through the item specific code.

In the above, the wireless terminals have a function of a personal area network (PAN) by being equipped with an infrared or RFID data transmit-receive device.

Specifically, the electronic commerce system according to the present invention in which an electronic commercial transaction is performed by collecting item information from a member, searching the item, placing an order for the item, and allotting a certain portion of the payment for the item to the member, is characterized by comprising:

a tag which includes information on the item specific code and is attached to the corresponding item for identification;

a code reader which can read in the item specific code included in the tag;
a memory device which stores the terminal specific number, the item specific code read in by the code reader, and information on the item, the member who purchased the item and other items which was purchased and registered by the above member;

a plurality of wired or wireless network terminals equipped with a data transmit-receive device which can directly transmit the data stored in the memory device to other terminal in case of searching, and can connect to the electronic commercial transaction server in case of placing an order, through the wired or wireless communication network;

a database which stores the terminal specific number, the item specific code, and information on the item, the member who had already purchased the item and other items which was purchased and registered by the same member; and

an electronic commercial transaction server in which order information is inputted from the wired or wireless terminal according to the decision of the new purchaser (a second member), the order is placed by transferring the order information including the terminal specific number and the item specific code to a supplier, the item information and the item specific code are stored and registered to said database with the purchaser information which was inputted by the purchaser him/herself, payment is performed through an associated financial institution terminal, and when the payment is completed, a certain portion of the payment is allotted to the (first) member in proportion to the degree of contribution,

wherein a second terminal of the new purchaser (the second member) among the plurality of wired or wireless terminals can search for the information including the terminal specific number, which is stored in the memory device of a first terminal of the first member, through the data transmit-receive device, save said information into the memory device of the second terminal, then order the item with transmitting said information to the electronic commercial transaction server.

further, wherein the second terminal, even if electric power of the first terminal is turned off, can turn on the power of the data transmit-receive device of the first terminal in a stand-by state, and receive the information contained in the first terminal,

wherein the first terminal, even if electric power of the second terminal is turned off, can turn on the power of the data transmit-receive device of the second terminal and receive the information contained in the second terminal.

Said plurality of terminals may further comprise a digital camera, and is characterized in that information on the item coordination which is made by the member can be inputted, by taking a picture of the appearance of the member coordinated with the item. Accordingly, the second member can instantly utilize the item coordination of the first member inputted through the digital camera, without separately searching for the item coordination of the first member.

When the second member is fascinated with the appearance of the item coordinated with the first member, 1) in case that the first member is with his/her terminal, the second member can receive the terminal specific number of the first member and the item information through the infrared or RFID transmission device of the wireless terminal, regardless of the on-off state of the first terminal, or 2) in case that the first member is not with his/her terminal, the second member can input the picture image of the first member through the digital camera of the second terminal and read in the item tag of the first member through the reader of the second member to receive the item specific code and item information.

The second member can search for, from the first member, the terminal specific code and digital picture of the first member, and receive the item specific code in the form of a number, a bar code or a tag chip specific code of the item purchased by the first member. After the second member searched or placed an order for the item, the terminal specific number and digital picture of the first member, the item specific number of the item purchased by the first member, and if any, purchase record of the item database of the first member in the terminal of the first member are saved in the second terminal of the second member. Consequently, the information stored in the terminal of the second member includes 1) the terminal specific number of the second member, 2) an item database of the second member in which purchased item information, the item specific code read in by the second member, pictures of each item, and the like are stored, and 3) the information received from the first member including the terminal specific number, pictures from the first member, the item specific code and item specific codes of other items purchased by the first member.

Further, from the terminal of the second member, a third member can receive information on the second member, i.e. 1) the terminal specific number of the second member, and 2) the item database of the second member including the purchased item information, the item specific code read in by the second member, pictures of each item, and the like. Optionally, the third member can decide to receive the information on the first member. The terminal of the third member also has its own terminal specific number, pictures of items of the third member, and item specific codes of other items purchased by the third member.

Exemplary item specific codes installed in the tag chip are represented in the following table.

| | |
|---|---|
| Purchaser (seller) specific number | KOR-Su-1808418 |
| Supplier specific number | KOR-Su-2808418 |
| Item composition | Pure wool 80%, poly-20% |
| Item style | Slim-and-long |
| Dimension (Size) | 100 |
| Color | Red |
| Design (Image) | N/A |

Such item specific code can be recorded on a tag chip, since its manufacturing, or recorded by the first member who purchased the item by using an infrared or RFID data transmit-receive device, etc. In the latter case, the tag chip should be a type of EEPROM of flash memory.

Further, the electronic commerce system of the present invention is characterized in that, the information being transmitted from the second terminal to the third terminal is limited to information on the purchased item of the second terminal user among the information contained in the second terminal, considering the memory capacity.

Moreover, the electronic commerce system of the present invention in which the third terminal of another purchaser (the third member) among the plurality of wired or wireless terminals can search said information from the second terminal of the second member through the data transmit-receive device, and save the information into the memory device, then place an order for the item, is characterized in that among the information received from the second terminal, if there is no information that the second member purchased the item, the electronic commercial transaction server will not allot a certain portion of the payment to the second member.

Further, the electronic commerce system of the present invention in which the third terminal of another purchaser (the third member) among the plurality of wired or wireless terminals can search said information including the terminal specific code from the second terminal of the second member through the data transmit-receive device, and save the information into the memory device, then place an order for the item, is characterized in that among the information received from the second terminal, if there is no information that the second member purchased the item, the electronic commercial transaction server will allot a certain portion of the payment, which is smaller than that of the first member, to the second member.

Further, the electronic commerce system of the present invention in which the third terminal of another purchaser (the third member) among the plurality of wired or wireless terminals can search said information including the terminal specific code from the second terminal of the second member through the data transmit-receive device, and save the information into the memory device, is characterized in that among the information received from the second terminal, if there is no information that the second member purchased the item, the third terminal cannot place an order for the item.

The tag may be in the form of a label where a series of numbers and/or a bar code is represented as the item specific code, or an integrated circuit chip which stores the item specific code. The label or integrated circuit chip is attached to or installed in a certain position of the item.

When the item specific code is in the form of a series of numbers, said purchaser can search for the item by inputting the numbers into the wired or wireless terminal, and directly transmit the item specific code to other wired or wireless terminal, or place an order to the electronic commercial transaction server through the numbers, thereby requiring no separate code reader.

When the item specific code is in the form of a bar code, said purchaser can read in the item specific code with a bar code reader, then connect the reader to said wired or wireless terminal and transmit the item specific code read in by the bar code reader to said electronic commercial transaction server or directly to other wired or wireless terminal.

When the tag is in the form of an integrated circuit chip containing the item specific code, said purchaser can read in the item specific code with a chip reader, then connect the reader to said wired or wireless terminal and transmit the item specific code read in by the chip reader to said electronic commercial transaction server or directly to other wired or wireless terminal.

The wired or wireless terminal herein, may be a personal computer which can be connected to the electronic commercial transaction server through the Internet, or a mobile communication terminal which can be connected to the electronic commercial transaction server through the wireless communication network.

The code reader such as a bar code reader or chip reader may be connected to with said personal computer or mobile communication terminal then used together, or may be used separately to read in the item specific code, then be connected to the personal computer or mobile communication terminal to read out the stored item specific code and transmit it to the electronic commercial transaction server for searching the corresponding item.

For example, when the first terminal places an order for a certain item, the order data is saved in the server, and the order is transmitted from said first terminal or the server to its manufacturer. The manufacturer produces the certain item based on the order data stored in the server, attaches an integrated circuit chip to the item and delivers it to the user of the first terminal through a delivery agency. In this while, the manufacturer transmits data concerning the produced item to the server, and the server saves the data.

In the meantime, the user of the first terminal who received the item confirms the data concerning the delivered item by connecting to the server, then downloads and saves the data to his/her own first terminal. The integrated circuit chip attached to the item and the first terminal containing the item data can be searched by the second or third terminal for the data concerning the item.

Further, the method of electronic commerce according to the present invention in which an electronic commercial transaction is performed by collecting item information from a member, searching the item, placing an order for the item, and allotting a certain portion of the payment for the item to the member, is characterized by comprising:

1) a step of first purchase, in which an item specific code given to the corresponding item and information concerning the item are read in by a code reader, then further saved to a memory device of the wired or wireless terminal which contains information on the first member who first purchased the item, terminal specific number and other items which were purchased by said member;

2) a step of data saving by a second member, in which a new purchaser (the second member) who wishes to search and/or purchase the same item purchased by the first member, receives the terminal specific number, the item specific code, and information concerning the item, the first member and other items which were purchased by the first member from the first terminal of the first member, through a data transit-receive device of the second terminal of the second member and save said information in the memory device of the second terminal, and/or connects to the electronic commercial transaction server through the wired or wireless network to transmit the order information;

3) a step of data saving and order by a third member, in which other new purchaser (the third member) who wishes to search and/or purchase the same item which was purchased by the first or second member, receives the terminal specific number, the item specific code, and the information concerning the item, the first and second member and other items which were purchased by the first or second member from the second terminal of the second member, through a data transmit-receive device of the third terminal of the third member, and save said information in the memory device of the third terminal, then connects to the electronic commercial transaction server through the wired or wireless network to transmit the order information;

4) a step of taking the order, in which the electronic commercial transaction server receives the order information from the third terminal of the third member to transmit again said order information including the item specific code to a supplier's terminal, while saving information concerning the item including the terminal specific number, the item specific code, and information on said members into its database; and

5) a step of allotting a certain portion of the payment for the item, in which when the purchaser completes the payment for the item, said electronic commercial transaction server allots a certain portion of the payment to the plurality of members as a reward, in proportion to the degree of contribution.

In the above method, the third terminal of the third member can search the information in the second terminal of the purchaser (the second member) through the data transmit-receive device of the third terminal, save the information to its memory device, and place an order for the item, while in the step 5), if there is no information that the second member purchased the item in the database, the electronic commercial transaction server may not allot a certain portion of the payment to said second member.

Further, in the above method, the third terminal of the third member can search the information in the second terminal of the purchaser (the second member) through the data transmit-receive device of the third terminal, save the information to its memory device, and place an order for the item, while in the step 5), if there is no information that the second member purchased the item in the database, the electronic commercial transaction server may allot a certain portion of the payment, which is smaller than that of the first member, to the second member.

Further, in the above method, the third terminal of the third member can search the information in the second terminal of the purchaser (the second member) through the data transmit-receive device of the third terminal, save the information to its memory device, and place an order for the item, while in the step 3), if there is no information that the second member purchased the item in the database or the second terminal of the second member, the third terminal cannot place an order for the item.

Hereinafter, with reference to the accompanied drawings, embodiments according to the present invention are described in detail.

Each member and his/her terminal hereinafter, are represented to be the same symbol, for instance, the first member and the first terminal may be represented with the same number 201.

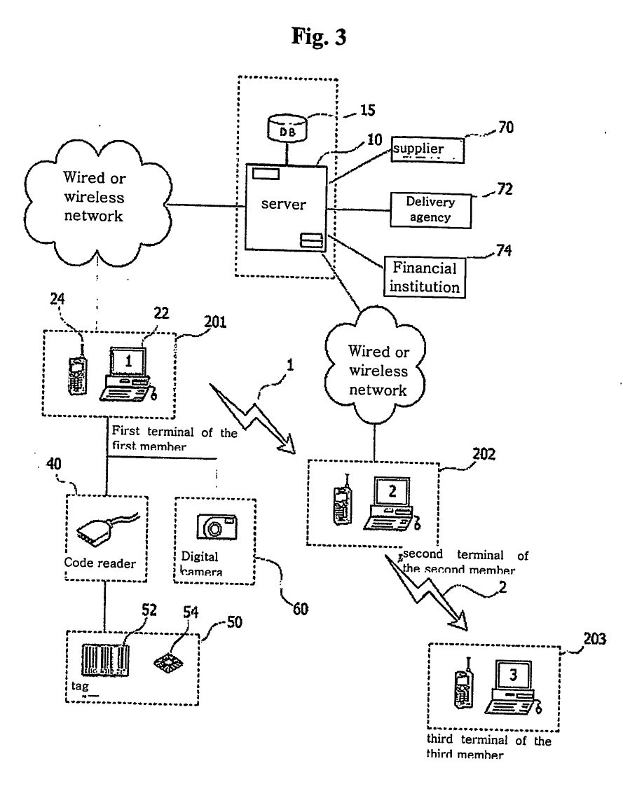

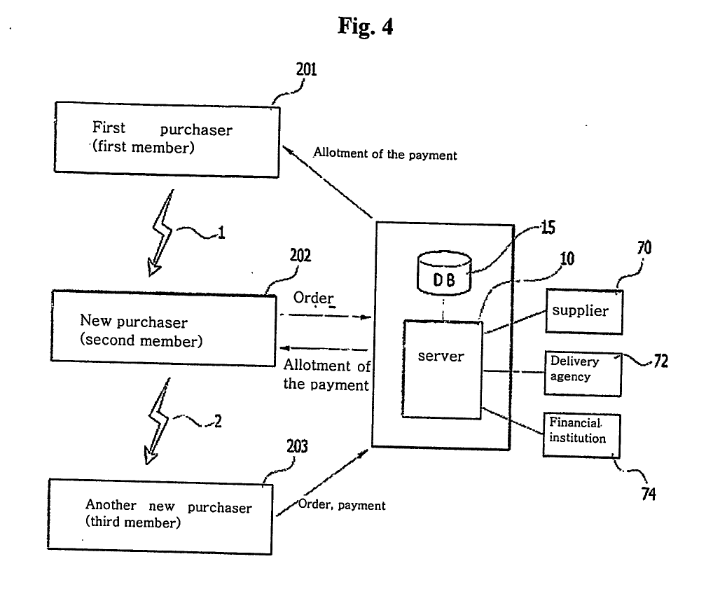

FIG. 3 is a schematic configuration view which roughly illustrates the electronic commerce system according to the present invention, and FIG. 4 is a block diagram which roughly illustrates the configuration and method of the electronic commerce system according to the present invention.

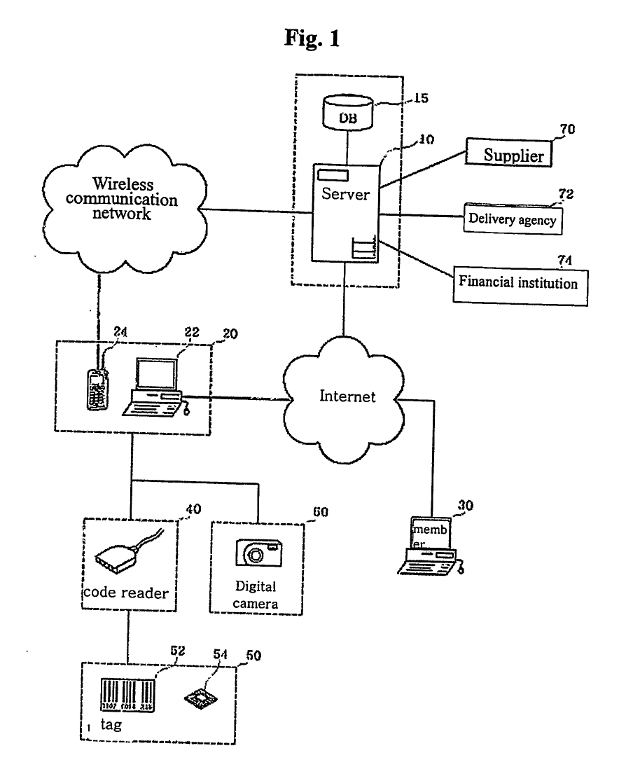

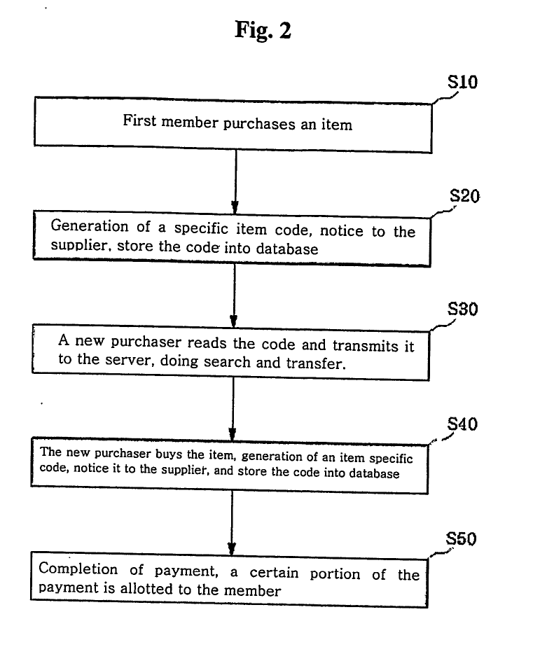

FIG. 3 is different with the FIG. 1 in its communication among terminals including the first terminal (201) of the first member, the second terminal (202) of the second member and the third terminal (203) of the third member. In FIG. 3, information on the item and the like is, not communicated through the wired or wireless communication network, but is directly communicated through a separately provided data transmit-receive device equipped in each terminal.

Herein, the wired or wireless communication network means the wired or wireless Internet and conventional telephone communication, while the separate data transmit-receive device means a device, which can communicate directly and mutually between each terminal positioned in a short distance range, i.e. in several meters, such as an infrared (IR) data transmit-receive device or RFID (Radio Frequency Identification) device and the like.

In prior arts, when the second member (202) who is a new purchaser meets the first member (201) in real life, is fascinated with the item purchased by the first member (201), and wishes to purchase the same item, the second member should read in the item specific code contained in a tag (50) attached to the item of the first member, through a code reader (40), then connect the reader to a mobile communication terminal (24) or a personal computer (22) to transmit the item specific code to the electronic commercial transaction server (10), and place an order with payment.

Meanwhile, in the present invention, the first member who first purchased the corresponding item, reads in the tag attached to the item through the code reader (40) connected with the first terminal (201), saves it, and later, when the second member (202) who is a new purchaser of the item meets the first member (201) in real life, and is fascinated with the item purchased by the first member (201) and wishes to purchase the same item, the second member should receive the item specific code stored in the memory device of the first terminal (201) and save it into the second terminal (202) through the data transmit-receive device installed in the second terminal, then transmit the information through the wired or wireless communication network to the electronic commercial transaction server (10) for placing an order with payment. Then, the electronic commerce transaction server (10) takes the order and payment, as well as saves the received item specific code, and information on the item, the first and second member and other items which were purchased by the first and/or second member into the database (15). Further, the electronic commercial transaction server (10) will allot a certain portion of the payment made by the second member to the first member.

Moreover, when the second member (202) who is a new purchaser meets the first member (201) in real life, is fascinated with the item purchased by the first member (201), and wishes to purchase the same item of the first member, the second member can receive and search the item specific code along with the information on the first member and other items which were purchased by the first member through the data transmit-receive device installed in the second terminal (202), from the memory device of the first terminal (201).

In the meantime, when the information stored in the second terminal (202) of the second member is transferred again to the third terminal (203) of the third member, purchase of the item by the third member may be prohibited, or even though purchase may be allowed to the third member, allotment of the payment by the third member is not given to the second member, depending on purchase of the item by the second member. These can be performed by two methods described as follows: firstly, providing separate memory field to the information to be stored in each terminal, in which the purchase record of the previous member concerning the item is stored and checked out for admitting or prohibiting a purchase order from the third terminal (203), or secondly, providing another memory field to the database (15) associated with the electronic commercial transaction server (10), in which when a purchase order with payment from the second terminal is not present in the corresponding item information, although a purchase order from the third terminal could be received, the purchase order from the third terminal (203) is rejected.

When a new purchaser who is the second member wishes to purchase the same item after seeing the first purchaser, i.e. the first member with the item, for instance clothes, the second member can 1) take a picture of the clothes in real life, 2) input the number, bar code, or specific chip number attached to the clothes, and 3) connect the second terminal to the first terminal, then the first terminal specific number and the member search record including above 1), 2) and 3) are stored in a separate memory field of the second terminal of the second member, thereby the second member can search and purchase the item. While, when another new purchaser who is the third member wishes to purchase the same item purchased by the second member, the third member can search the item not in the search record of the second member including 1), 2) and 3) (the picture per se is not possible to be shown and searched), but in a memory field in the database of the second member wherein the item purchased by the second member, i.e. the item which had been manufactured and delivered to the second member is stored. Further, the second member can make the database of items owned by him/herself to build his/her own individual or home shopping mall. The items in the database of the second member can be provided through his/her own sale site where other person can place an order, while items which are not purchased by the second member, i.e. items of the first member, a supplier, a supplier who manufactures the item by its own, or a company which advertises items that are not purchased or owned by the company itself, can be searched and purchased at other separate site, then a defined little amount of profits can be made to the first member, or a supplier such as manufacturing plant or company, or a service provider managing the electronic commercial transaction server, respectively, as allotment of the margin (profits). For providing the specific item code in the form of a number, a bar code or an item specific number, of an item which had not been purchased by the second member to the memory field of the second terminal, thereby allowing to use for item search or sale, the second member should be registered to the internet service provider managing the electronic commercial transaction server. Further, the second member should report him/herself as a sales agency and pay tax for the income. The Internet service provider for the electronic commercial transaction server and the supplier such as a second or a third member also should pay tax for the income, and this whole process is managed by the server. When the second member purchases an item, the second member register his/her own online shopping mall (home shopping mall) to receive a specific sales registration number which is recorded during data transmit-receive through a wireless terminal phone number or specific number. Based on the record, the second member may receive more amount of allotment for his/her own purchase (service provider for the server, and supplier of the second member). When the third member made a purchase of the item from the second member who did not purchase the item, but only served as a advertising agency, more amount of allotment will be given to the service provider for the electronic commercial transaction server, supplier (manufacturing plant) and the first member, but only small amount of allotment will be given to the second member and an advertising agency (i.e. buyer) who only opened an internet site for advertising the item. With respect to a claim of certification of the second member, i.e. call particulars and purchase order, 1) when purchase has been made, it is recorded to a memory field A, and it may be advertised and marketed, 2) when purchase has not been made, it is recoded to a memory field B, in case of a consignment sale, the allotment will be made from the service providing company for the electronic commercial transaction server, or from the economy or financial section of a mobile service providing company. Tax will be automatically paid. The registered home shopping mall number is always recoded and stored in the individual server. In cases other than sales of the purchased item, when a demand for withdrawal is made to the service providing company for the electronic commercial transaction server by the advertisement consigner, the first member and consignment sales agent of the supplier (the second member), for some members who caused troubles such as a third, a fourth, a fifth to a 100^{th} member with proper grounds through a right procedure, the service providing company for the electronic commercial transaction server can control the whole system by withdrawing the power of the consignment advertising agency or making incapable of placing an order.

Concerning the economy over the whole transaction, including purchase order, allotment of the profits and the like, payment is always performed through the service provider for the electronic commercial transaction server.

In addition, although a purchase order from the third terminal (203) is received to a separate memory field in the database (15) associated with the electronic commercial transaction server (10), when a purchase order with payment from the second terminal is not present in the corresponding item information, it is possible to make that the server will not allot a certain portion of the payment to the second member.

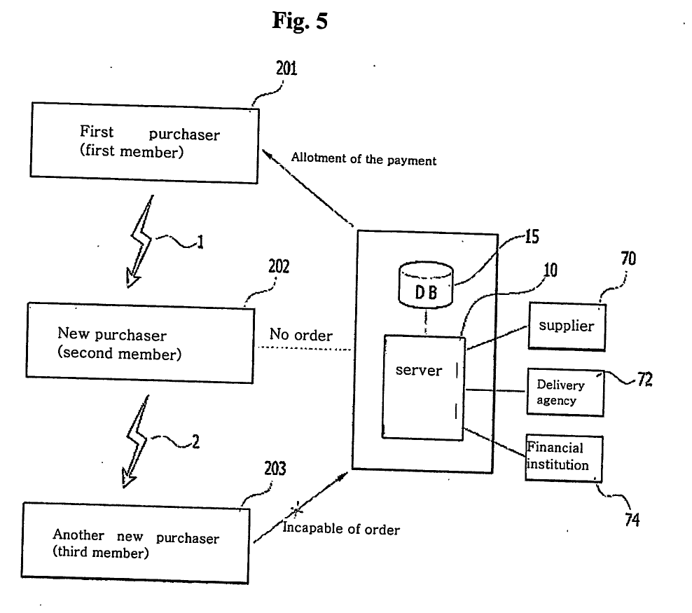

FIGS. 4 and 5 are a block diagram which roughly illustrates the configuration of the electronic commerce system and method according to the present invention.

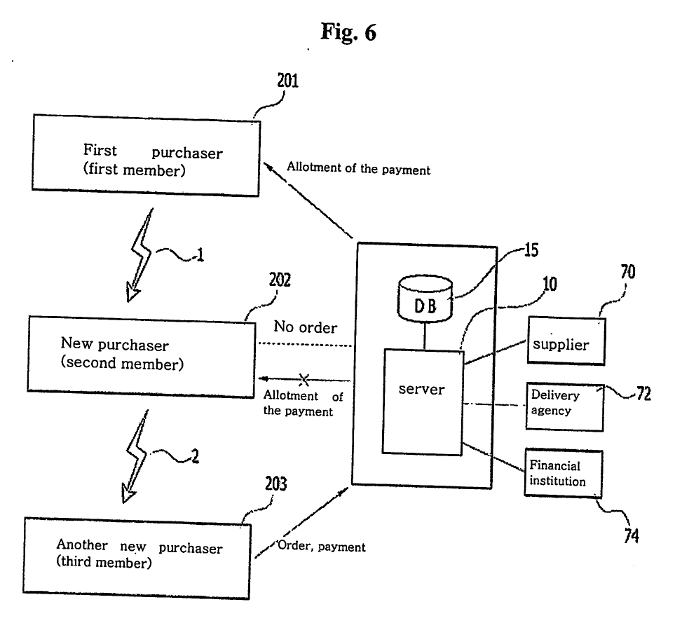

Specifically, FIG. 4 is a block diagram showing the case that all the members including the first, second, and third member purchased the item, and it illustrates a certain portion of the payment by the third member is allotted to the first member and the second member, respectively. In FIGS. 5 and 6 provide block diagram showing the case that the first and the third member placed an order for the item, but the second member only searched the item and transmitted the item information to the third member without purchasing the item.

Regarding the case when the second member did not place an order for the item, FIG. 5 illustrates that the third member who received the item information from the second member cannot place an order, and FIG. 6 illustrates that the third member who received the item information from the second member may place an order for the item, but a certain portion of the payment is not allotted to the second member. The amount of allotment to the second member can be adjusted to be smaller than others, and it can be determined according to the different ratio of allotment by the service provider of the electronic commercial transaction server.

In the meantime, the item specific code may be in the form of a series of number, a bar code, and an integrated circuit chip. In the form of a number and a bar cord, the item specific code is attached to the item as a type of label, and in the form of an integrated circuit chip, the item specific code is installed or included in the item.

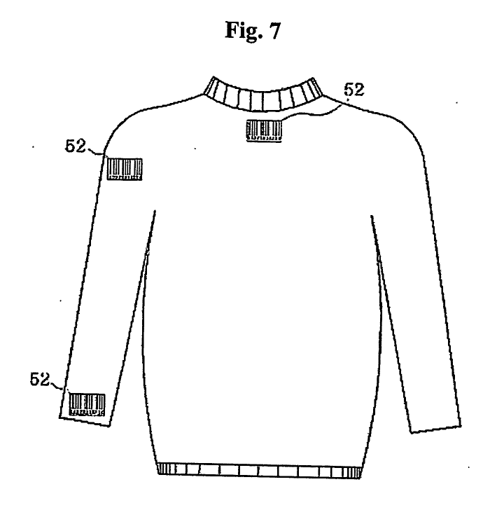

One embodiment of a label attached to its corresponding item is illustrated in FIG. 7. FIG. 7 provides clothes as an example of item, wherein the label (52) in which a series of number and bar code are represented is attached to one or more places of the clothes such as sleeve, shoulder, back neckline and the like. A purchaser (second member) may obtain the item specific code from the member wearing the clothes, by reading in the numbers represented on its label (52) or the bar code using a bar code reader. The second member can carry out the item code search of the first member by clicking on the terminal reader number or terminal specific number of the first member with the terminal reader of his/her own.

The clothes have been provided by FIG. 7 as an example of the present invention, however without being limited by this, the present invention can be applied to various items. Particularly, for an integrated circuit chip, due to its size which has been developed to have a grain of rice, it can be easily attached to or installed in a certain position of the corresponding item.

When the item specific code is in the form of a series of numbers, a code reader would not be necessary and the purchaser can input the numbers manually. It means that the purchaser can input the series of numbers as the item specific code through a personal computer (22) or mobile communication terminal (24), and transmit it through a separate data transmit-receive device such as an infrared data transmit-receive device to other wired or wireless terminal directly, or when placing an order, to the electronic commercial transaction server (10) through a wired or wireless network.

When the item specific code is in the form of a bar code, the purchaser may read in the item specific code using reading in the bar code using a bar code reader. By reading (clicking) the wireless terminal specific number of the first member the item specific number search or reading can be carried out.

Currently, various types of the bar code reader are manufactured and marketed, therefore, one can be used in connection with the personal computer (22) or the mobile communication terminal (24), and other can be used by itself, which can read in and save the item specific code, draw out the stored item specific code by connecting to the personal computer (22) or the mobile communication terminal (24), and transmit the code to other wired or wireless terminal and/or the electronic commercial transaction server (10).

When the item specific code is stored in an integrated circuit chip, the purchaser would read in the item specific code using a chip reader, and, in the same manner as described above for a bar code, transmit it to other wired or wireless terminal and/or the electronic commercial transaction server (10) through a personal computer (22) or a mobile communication terminal (24). However, since the integrated circuit chip can store more information than the bar code, for example, item information such as material or manufacturer as well as the item specific code, the purchaser may directly obtain such information on the item through the integrated circuit chip attached to or installed in the item

The bar code reader or chip reader is a kind of transducer which can read in the item specific code included in the bar code or the integrated circuit chip and convert it to an electric signal which can be recognized by the personal computer (22) or mobile communication terminal (24) and the electronic commercial transaction server (10). These bar code reader and chip reader are currently commercialized in a variety of fields, thus details of these are not described further in this specification.

Herein, when using the personal computer (22), it would be difficult, in many cases, to read in the bar code by connecting the bar code reader with the personal computer, since it is not potable. However, when using the mobile communication terminal (24) for example, a mobile phone or a PDA, it would be much convenient to obtain the item specific code of an attractive item by connecting the bar code reader directly to the mobile phone or the PDA, regardless of time and place, and search for the item. The same is applied to the integrated circuit chip.

When using the mobile communication terminal (24) such as a mobile phone or a PDA as a wired or wireless terminal of the purchaser, it would be preferred to use a bar code reader or a chip reader being conveniently attached to the mobile phone or the PDA. It is also possible to install the bar bode reader or the chip reader into the mobile phone or the PDA in one piece. Further, it is possible to take a picture by using a digital camera.

FIG. 8 illustrates an exemplary embodiment wherein the code reader and data transmit-receive device are installed in the mobile phone as a terminal in one piece. As illustrated in FIG. 8, the code reader (42) is installed in the front side of the terminal (24), and the control button (44) is installed in one side of the terminal. The code reader (42) may be a reader for number, bar code or chip. Since, in recent years, such bar code reader or chip reader has been miniaturized, it may be easily embodied to manufacture the terminal and the code reader in one-piece by adding a module which carries out a function of a code reader to the terminal.

By using the above-described terminal in which the code reader is installed, the purchaser can always conveniently read in the item specific code of an item that he/she wishes to purchase. Specifically, the purchaser can read in the item specific code included in the bar code or the integrated circuit chip by approaching the code reader installed in the front side of the mobile phone toward the label or the integrated circuit chip.

In the above, it would be much convenient to use, if electric power of the data transmit-receive device can be turned on, even though electric power of the terminal is turned off, i.e. in a stand-by state. For example, it would be much more convenient that, even if electric power of the first terminal (201) is turned down, the second terminal (202) can power on the data transmit-receive device (451) of the first terminal (201) and receive the information from the terminal (201), while the third terminal (203) can turn on electric power of the data transmit-receive device (452) of the second terminal (202) and receive the information from the second terminal (202), even if the power of the second terminal (202) is turned out.

A user can transfer a signal from his/her terminal to other user's terminal then carry out search by clicking on the terminal specific number of the other user. When the user takes a picture of the other user who is currently wearing the clothes, and inputs the picture, the item specific code of the clothes in the picture may be provided. When the other user takes a picture of him/herself by using the his/her own terminal or inputs the item specific code with the reader, the item is automatically coordinated according to the picture, thus when the user searches the item, the user can get the current coordination. When the other user did not make a coordination of the current clothes, however the user has the item specific code or photographed and inputted image of the item, the user can input the image into the other user's terminal and coordinate it to get the current coordination.

In the above, it is preferred that, considering the memory capacity, the information which may be transmitted from the second terminal (202) to the third terminal (203) is limited to only the purchased item information of the second terminal (202) user among the information contained in the second terminal.

Moreover, when the terminal further has a digital camera, a member can take a picture of other member's appearance coordinated with the same item and input the coordination information of the item, then a member who receives the information can more easily coordinate the item. For example, when the second member takes a picture of the first member wearing a hat, a shirt, a pair of trousers or footwear and the like, and input the item data to the terminal (202) of the second member, the second member can directly use the coordination of the first member without inconveniently searching the above 4 items and coordinating them respectively, thereby more convenient and easy coordination is possible.

Hereinafter, embodiments of a method carrying out the electronic commerce according to the present invention are described, with reference to the drawings.

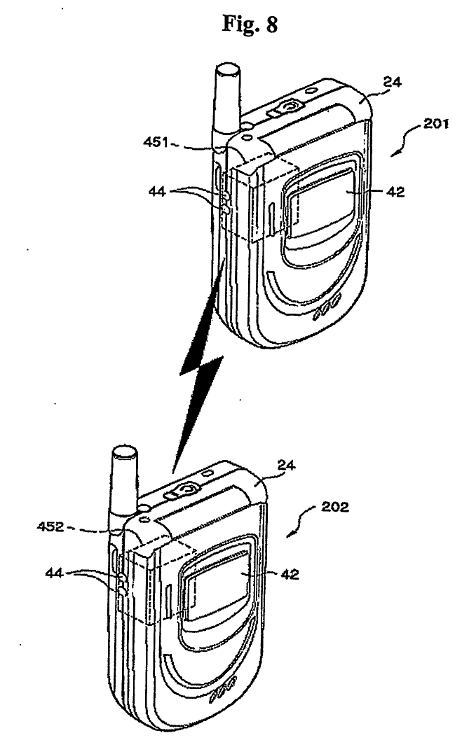

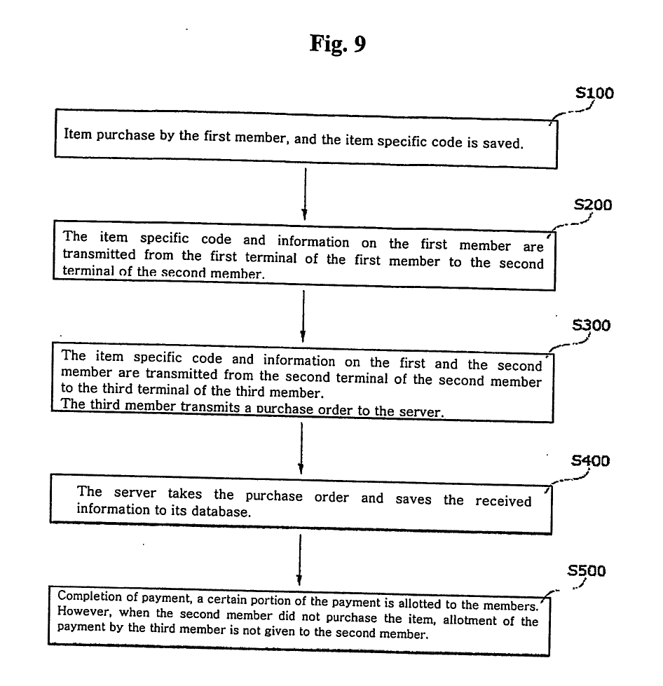

FIG. 9 is a flow chart which illustrates one embodiment of the method of the electronic commerce according to the present invention. For instance, when a second member is fascinated with the item purchased and worn by the first member in real life, and wishes to purchase the same item and imitate the fashion trend of the first member, there can be two cases: a case that the second member searches the items purchased by the first member and purchases them; and another case that the second member searches the items purchased by the first member but does not purchase the item. With respect to each case is discussed below. When the second member did not purchase the item, it should be considered that whether the third member who received the information on the corresponding clothes from the second member can place an order for the clothes and/or when the order with payment is completed by the third member, how to conduct allotment of the payment.

Firstly, in the first step (S100), the first member makes first purchase of the item, then reads and saves the item specific code and information concerning the item into the first terminal (201) through a code reader. In the above, the first terminal already contains information on the first member and other items which were purchased by the first member, and the information on the newly purchased item is additionally inputted therein through the code reader (a step of first purchase by the first member).

As the foregoing description, the item specific code may be in the form of a series of numbers, a bar code, an integrated circuit chip, and the like. The purchaser reads in the item specific code through the bar code reader or chip reader and transmits the item specific code to the electronic commercial transaction server by using a wired or wireless terminal such as a mobile communication terminal or a personal computer to search the corresponding item with ease. When the item specific code is in the form a series of numbers, the numbers can be manually inputted or read in by the reader, thereby other separate code reader may not be necessary. When using a mobile phone or a PDA as a mobile communication terminal, it will be convenient to directly connect the code reader to the terminal. The code reader may form a one-piece with the mobile communication terminal. Regarding this, the above description can be applied, thus further details are not described herein.

Next, in the second step (S200), for example, when the second member is fascinated with the item purchased and worn by the first member in real life, and wishes to search and/or purchase the item, the new purchaser, i.e. the second terminal of the second member can receive information on the terminal specific number, the item specific code, the item itself, the first member and other items which were purchased by the first member as well as other information on items which has not been purchased by the first member, just for advertising and sale, from the first terminal, through the data transmit-receive device of the second terminal, and save the information into the memory (a step of search and data saving by the second member). In the above, the first terminal can automatically transmit the terminal specific numbers and information on the item specific code and others stored in its memory to the second terminal, by operating the data transmit-receive device, for instance an infrared data transmit-receive device or RFID, etc. of the second terminal toward the first terminal.

In receiving the whole document regarding consignment sale of a non-purchased item from the first member or a supplier, the second member can obtain it from the wireless terminal of the first terminal, by searching for the specific number of the first member, or by receiving it from the service providing company which manages the electronic commercial transaction server. Considering the memory capacity, 1) photographed image, 2) terminal specific number and 3) the item specific number are inputted.

Regardless of state of electric power of the first terminal, when the first terminal is on, the information can be directly transmitted to the second terminal, while the terminal is off, the second terminal turns on the data transmit-receive device of the first terminal, then the terminal specific number of the first terminal is provided on the screen of the second terminal, and the clothes coordination of the user of the first terminal may be provided by search. When the second terminal takes a picture of the item by using the digital camera and input it, the current item coordination may be represented. The second terminal can conduct search and place an order for the item. It is recorded and saved to the second terminal, and the 1) the first terminal specific number, 2) photographed and inputted image and 3) the item specific code of the clothes purchased or shown in real life are represented. When the third terminal takes a picture of the second member coordinated with the item, and reads in and saves the information, only coordination of items which were purchased by the second member can be provided and searched. When searching for non-purchased items, other procedure is conducted.

In the meantime, there can be two cases regarding the second step: one in which the second member transmits the purchase information by connecting to the electronic commercial transaction server through a wired or wireless network, and the other in which the second member does not transmit the purchase information.

Firstly, the former case that the second member transmitted the purchase information for the corresponding item to the electronic commercial transaction server is considered.

In the third step (S300), the third terminal of a new purchaser (the third member) who wishes to search and/or purchase the item purchased by the first or the second member can receive the information on the terminal specific number, the item specific code, the item itself, the first and the second member and other items which were purchased by the first and the second member from the second terminal of the second member, through the data transmit-receive device of the third terminal, then save the information into the memory, and transmit it to the electronic commercial transaction server through a wired or wireless network (a step of data saving and placing an order by the third member).

In the fourth step (S400), the electronic commercial transaction server receives the order information from the third terminal of the third member, transfers the terminal specific number and the order information including the item specific code to the supplier's terminal, and saves the item information with the item specific code and information on the plurality of above members into the database (a step of taking the order)

The general procedure of placing an order, delivery and payment is as same as the conventional electronic commerce and does not constitute characteristic features of the present invention; therefore, more detailed description on this matter is not described further in this specification.

In the fifth step (S500), with completion of the payment, the electronic commercial transaction server will allot a certain portion of the payment to the first and the second member (a step of allotment of the payment).

In other words, a certain portion of the sales profit is paid back to the members. The method of allotment can be varied, for example in the form of reward points or remittance to the personal account of the registered member, by associating with the terminal of the financial institution, but not limited by any one of these methods.

Next, the case that the second member did not transmit the purchase order for the corresponding item, but only transmitted the terminal specific number and information including the item specific code and the like from the second terminal to the third terminal without purchasing the item, is discussed.

In the above case, in the fifth step (S500), the electronic commercial transaction server allots a certain portion of the payment by the third member to the first member, but does not allot to the second member. Since the second member did not purchase the item, it would be unfair to give allotment to the second member. However, in the light of the second member as an advertising agent in marketing the item, it is possible to give the second member a certain amount of allotment, which is smaller than that of the first member.

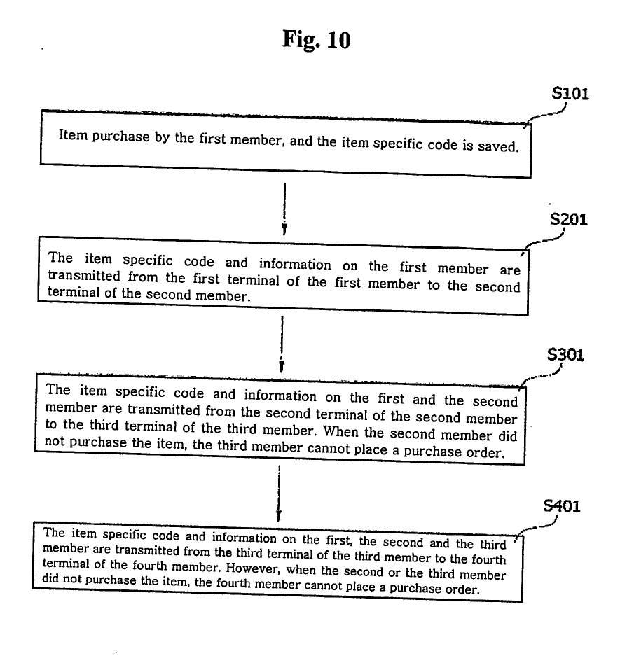

FIG. 10 is a flow chart which illustrates the case (S301) that when the second member did not purchase the corresponding item, the third member is not possible to place an order for the item. Additionally, a fourth member who received item information from the third member cannot place an order (S401), since the second and/or the third member did not purchase the item. The purchase allowance may be decided by the presence of a purchase record of the former member in each terminal or in the database (15).

Alternatively, when the purchase record presents in the supplier's terminal, the purchase record database of the supplier is also formed as a database in the terminal of the purchaser, and purchase was completed with payment including value added tax, etc., then it can be instantly confirm that the item has been purchased or not, by representing a certain record symbol added to the end of the item specific code of the purchased item on the terminal of the purchaser. Further, the online shopping malls are classified into a shopping mall selling purchased items, and a shopping mall selling non-purchased items, then above shopping mall information is saved, for applying graded allotment per sales.

Hereinafter, specific examples according to the forgoing FIG. 8 are described in detail as follows.

### EXAMPLES

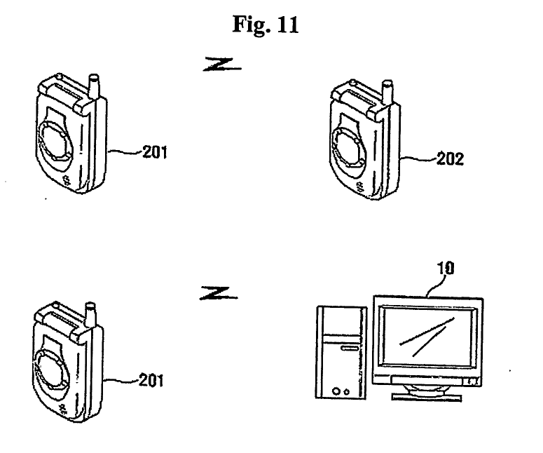

FIG. 11 is a concept diagram which represents the data transmit-receive between the wireless terminals according to the present invention. With reference to FIG. 11, it is a concept diagram how to carry out data transmit-receive, and data processing between the wireless terminals (201, 202) in order to practice the present invention.

Firstly, the wireless terminals (201, 202) may use, for the data transmit-receive, any one of modules selected from radio frequency (RF), infrared (R) and ultrasonic wave, and other various types of data transmission such as laser which can be practiced as the development of technique, RF-ID, bar code, USB, Bluetooth, Ubiquitous, IC-Chip and the like.

Further, the wireless terminals (201, 202) provide a hardware and a firmware (kind of software) designed to share data, for data processing. These are further described in detail in each example below.

Although the present examples represent a method for practicing data transmit-receive and data processing between the wireless terminals (201, 202), and a system using the method, it should be noted that the present invention can be applied to a method for practicing data transmit-receive and data processing between the wireless terminals (201, 202) with the server (10) and a system using the method, as it would be instantly understood by persons skilled in the art.

For applying above, the server (10) should share the data with the wireless terminals (201, 202), provide storage and offering of the data which flows in and out, and have hardware in a type of database and software.

The above wireless terminals (201, 202) and the server (10) are basically used for wireless communication, and depending on the system configuration, other mobile communication network such as PSTN, CDMA and the like may be further used, or communication method accessible to the internet network may be used.

The wireless terminals (201, 202) and the server (10) have their own specific code which can be extended to the maximum range as long as the specific codes are not overlapped.

Hereinafter, the data transmit-receive and data processing between wireless terminals (201, 202) are mainly described, and in the description, the entity which demands data from the wireless terminal (201 or 202) of the other party is defined as a wireless terminal A, and the entity offering the demanded data to the wireless terminal A is defined as a wireless terminal B.

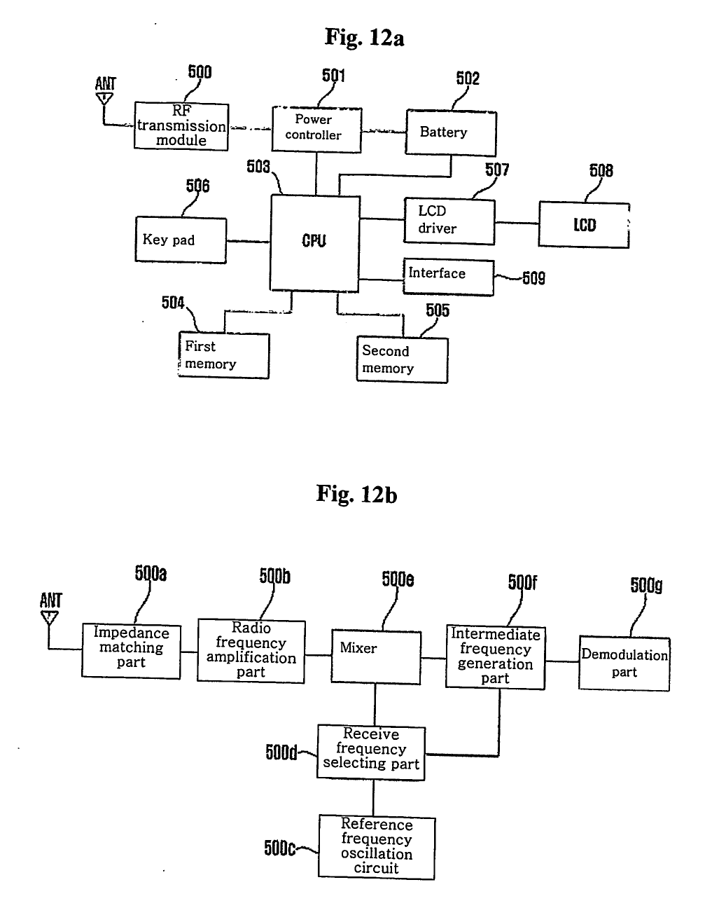

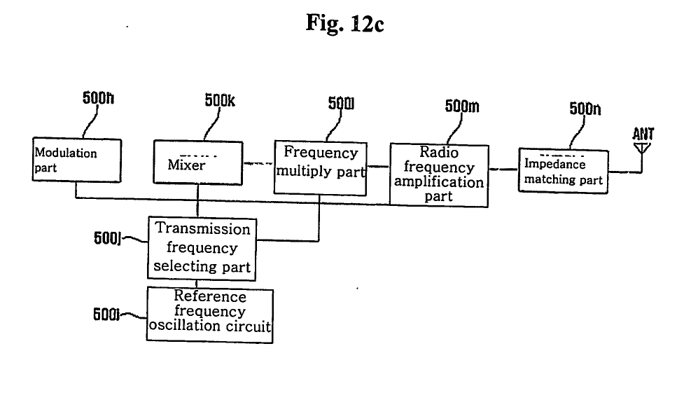

FIG. 12a is a block diagram which shows the control circuit of the wireless terminal adopting a RF module of Example 1 according to the present invention. With reference to FIG. 12a, the control circuit of the wireless terminals according to Example 1 comprises: the RF transmission module (50) which receives demanded data from other wireless terminal and also transmits data contained in its wireless terminal; a power controller (501) which can maintain electric power in a stand-by state when electric power of the wireless terminal is turned out by its user, and generate power control signals for driving the wireless terminal; a battery (502) which supplies electric power to the wireless terminal; a CPU (503) which is supplied with electric power from the battery (502) and conducts the whole system control, including data transmit-receive and processing responding to the data demand from other wireless terminal; a first memory (504) which stores the data transmitted through the above wireless transmission module (500) as well as provides the stored data; a second memory (505) in which a wireless terminal program including information of the above wireless terminal is stored; a key pad (506) which supports the operation by the user; an LCD driver (507) which carries out the output of data which has been transmitted or received and the operation by the user; and an interface (509) which supports a device connectable to the above wireless terminal.

Hereinafter, described are data transmit-receive and processing between the wireless terminals A and B constituted as above.

It is described with a provision that a user has data concerning an item that he/she wishes to purchase or sell in his/her own wireless terminal. For instance, when data concerning clothes that the user is currently wearing, has been stored in his/her own wireless terminal and other person is interested in the clothes, the procedure that the interested person obtains data concerning the corresponding item i.e. clothes is described below in detail.

1. Procedure of Obtaining Data of the Wireless Terminal B at the Wireless Terminal A

Firstly, when the user of the wireless terminal A is interested in the clothes which is worn by the user of the wireless terminal B, the user of the terminal A may approach the terminal A to the terminal B within the range being capable of data transmit-receive.

In the above, if there is a plurality of other wireless terminals within the range, in order to improve the reliability in obtaining the accurate data, the wireless terminal A needs to be positioned as near as possible to the wireless terminal B, or alternatively the user of the wireless terminal A may output a list of the responding wireless terminals and select the wireless terminal B among them.

As above described, after approaching the wireless terminal A to the wireless terminal B, the user of the terminal A can use the key pad (506) i.e., press a specific button which is pre-set for obtaining the data of the wireless terminal B.

When the specific button is inputted, i.e. pressed, data including a data demanding signal and a specific code of the wireless terminal A is transmitted to the wireless terminal B. Particularly, the above specific code of the wireless terminal A is used as a ground data by which the data obtained from the wireless terminal B can return to the right destination, i.e. the wireless terminal A, or by which a mileage or reward point is processed afterwards.

The wireless terminal B in a stand-by state receives the data demanding signal and the specific code of the wireless terminal A through the wireless transmission module (500).

However, when the wireless terminal B is not in a stand-by state but in a turned-off state, the system of the terminal B is forcibly turned on. It means that either one or all of the data demanding signal and the specific code, which have been transmitted from the wireless terminal A are used as a drive signal for the wireless terminal B. The drive signal controls the battery (502) through the power controller (501), i.e. supplying electric power from the battery (502) to the CPU (503) by consequently driving the whole system.

Once the system of the wireless terminal B starts to operate, the received data demanding signal and the specific code of the wireless terminal A are internally processed. In the process, firstly, it is determined whether the received data demanding signal and the specific code of the wireless terminal A are illegal electric wave, noise or normal signal. When it is determined to be illegal electric wave or noise, the signal is ignored, however when it is determined to be normal signal, the data concerning the item which is stored in the first memory (504) is read out, responding to the data demanding signal.

With completion of reading out the corresponding data, the CPU (503) will process the read-out data and the specific code of the wireless terminal B to a transmission data format.

In other words, the CPU produces a data format comprised of “wireless terminal A+wireless terminal B+item data”. The data format means that the corresponding item data stored in the wireless terminal B is transmitted to the wireless terminal A responding to the demand from the wireless terminal A. In addition, the item data may include more optional data such as the seller's address, characteristic features, color and size of the item and the like, and optionally include data that the user of the wireless terminal B desires to sell.

The data as processed above is transferred to the wireless terminal A by the wireless transmission module (500) via the CPU (503).

After receiving the processed data from the wireless terminal B, the wireless terminal A, firstly determines that the received signal is illegal electric wave, noise or normal signal. When the signal is determined to be illegal electric wave or noise, the wireless terminal A will ignore it; however when the signal is determined to be normal signal, the received signal is saved in its first memory (504). In saving the data, if it is reached to its data storage limit, message regarding this matter is outputted, so that the prior messages may be deleted or auxiliary memory may be used.

At the same time the received signal is saved, the received data is displayed on the LCD (508). The user of the wireless terminal A confirms the received data, and when purchasing the item afterwards, transmits the above-mentioned data format comprising “wireless terminal A+wireless terminal B+item data” to the seller of the item. With respect to this, the seller of the item may give mileage or points to the user of the wireless terminal B in reward of advertising the item in an indirect way. However, when the user of the wireless terminal B wishes to directly sell the item on his/her own, immediate purchase on the spot may also be possible.

In the meantime, if there is a plurality of wireless terminals around the wireless terminal B while the wireless terminal A transmits the data demanding signal and the specific code of the wireless terminal A to the wireless terminal B, the data demanding signal and the specific code of the wireless terminal A may be possibly transferred to the above plurality of wireless terminals. In this case, various wireless terminals which have received the data from the wireless terminal A will be forcibly driven to run and transmit its own specific code to the wireless terminal A, as described above. It will cause great inconveniences to the user of the wireless terminal A, since unnecessary data from various wireless terminals together with the desired specific code of the wireless terminal B are transmitted and stored at the same time, then the user should take a step of selecting the desired code of the wireless terminal B. In order to prevent this, in the present invention, data acquisition is conducted between the most near wireless terminals, and it can be achieved by approaching the user's terminal most near to the other wireless terminal which contains desired data. Further, the data demanding signal and the specific code of the wireless terminal A which have been transmitted to the various wireless terminals are deleted in the other respective wireless terminals, for preventing unnecessary data storage. In the wireless terminal A, each specific code of the various wireless terminals other than that of the wireless terminal B and the like is also deleted. The same is applied to a procedure of obtaining the data of the wireless terminal A at the wireless terminal B in the following description.

2. Procedure of Obtaining Data of the Wireless Terminal a at the Wireless Terminal B

This procedure is as same as the above-described procedure of obtaining data of the wireless terminal B at the wireless terminal A, except that the entity of demanding the data is changed from the wireless terminal A to the wireless terminal B, thus modified portion from the procedure 1 is only described as follows.

The wireless terminal B is approached to the wireless terminal A, i.e., the data demanding signal and specific code of the wireless terminal B are transmitted from the wireless terminal B to the wireless terminal A.

Then, the wireless terminal A, responding to the data demanding signal, reads out the data concerning the item stored in the first memory (504) and processes it with the specific code of the wireless terminal B to a transmission data format.

The transmission data format is processed to be comprised of “wireless terminal B+wireless terminal A+item data”. The data format means that the corresponding item data stored in the wireless terminal A is transmitted to the wireless terminal B responding to the demand from the wireless terminal B.

The data as processed above is transferred to the wireless terminal B by the wireless transmission module (500) via the CPU (503).

Then, the wireless terminal B saves the received signal to the first memory (504) and displays it.

When the initial state of the wireless terminal A or B was a turned-off (stand-by) state, the corresponding system preferably returns to its initial state with the completion of the data acquisition in the wireless terminal A or B.

FIG. 12b is a scheme which roughly illustrates the wireless data receiving device of the wireless terminal adopting a RF module according to the present invention. With reference to FIG. 12b, the wireless data receiving device of the wireless terminal according to the present invention comprises: an impedance matching part (500a) wherein the impedances between the antenna (ANT) and the wireless circuit are matched; a radio frequency (RF) amplifying part (500b) wherein radio frequency amplification and wave form shaping are conducted in order to demodulate FSK data inputted through the antenna (ANT); a reference frequency oscillation circuit (500c) which generates reference frequency; a receive frequency selecting part (500d) wherein the receive frequency is determined by using the oscillated frequency from the above reference frequency oscillation circuit (500c); a mixer part (500e) wherein intermediate frequency is formed by using the determined receive frequency and the received frequency; an intermediate frequency generation part (500f) wherein the intermediate frequency is generated from the inputted wave form by using the frequency which has been determined at the above receive frequency selecting part (500d), in order to receive accurate data; and a demodulation part (500g) wherein the demodulated FSK signal is modulated to TTL level in order to use the FSK signal as a general control signal.

FIG. 12c is a scheme which roughly illustrates the wireless data transmission device of the wireless terminal adopting RF module according to the present invention. With reference to FIG. 12C, the wireless data transmission device of the wireless terminal according to the present invention comprises: a modulation part (500h) for modulating the general control signal in TTL level to a FSK signal; a reference frequency oscillation circuit (500i) which generates reference frequency; a transmission frequency selecting part (500j) wherein transmission frequency is determined by using the oscillated frequency from the above reference frequency oscillation circuit (500i); a mixer part (500k) wherein the frequency to be transmitted is formed by using the transmission frequency which is determined at the above transmission frequency selecting part (500j); a frequency multiply part (500l) for conducting frequency multiply in order to form a frequency for transmission by using the frequencies from the above reference frequency oscillation circuit (500i) and the above transmission frequency selecting part (500j); a radio frequency amplification part (500m) wherein the amplification is achieved by compounding a signal in TTL level with the above-multiplied frequency; and an impedance matching part (500n) in which the impedances between the antenna (ANT) and the wireless circuit are matched.

With reference to FIG. 12b and FIG. 12c, in receiving data from the outside, unnecessary noises, spurious and the like are removed from the wireless signals including for example, specific number, item number, item color, etc., in the impedance matching part (500a), therefore only normal wireless signals can be received. The received wireless signal is very weak, thus for active operation, it is inputted to the radio frequency amplification part (500b) for amplification. The wireless signal inputted to the radio frequency amplification part (500b) is amplified to a wireless signal having 1 dB˜10 dB. The amplified wireless signal from the radio frequency amplification part (500b) itself is hundreds of MHz to thousands of MHz, and such signal with high frequency cannot be demodulated, therefore a modification of the frequency to have low frequency is needed for easy demodulation. For the modification, the mixer part (500e) conducts a frequency modification of the inputted wireless signal of hundreds of MHz˜thousands of MHz to a signal of hundreds of KHz range. With regard to this, the following frequency modification equation is used.
Intermediate frequency=Receive frequency−Reference frequency

The reference frequency oscillation circuit (500c) oscillates the frequency modification value which is a difference between the received frequency of the wireless signal to be modified and the desired intermediate frequency, i.e. the range between the frequencies before and after the modification, by using X-Tal (crystal and TCXO) and the like.

Since the receive frequency is mixed in the mixer part (500e) by using the oscillation frequency oscillated in the reference frequency oscillation circuit (500c), then the resulted intermediate frequency shows weak fluctuations, the receive frequency selecting part (500d) automatically controls the modification amount, according to the above weak fluctuations in frequency, in order to provide constant intermediate frequency.

The wireless signal with modified frequency is applied to the intermediate frequency generation part (500f) to obtain a wireless signal having intermediate frequency. Then, the signal is amplified, in a stable manner, to a wireless signal having 10.7 MHz/455 KHz which can be smoothly demodulated in the demodulation part (500g). The above demodulation part (500g) can modify the wireless signal to a TTL signal, which may be set to 5V Large in TTL level, being able to recognized by CPU and peripheral controllers.

A constant voltage control circuit which is not represented herein is an important part in wireless transmission/receive device, since in many cases of RF circuit, receive frequency or OSC oscillation reference frequency may be modified by weak voltage fluctuation and sometimes such modification makes impossible to conduct wireless communication in desired frequency. Therefore, in order to present such modification depending on the voltage fluctuation, in the RF circuit of the present invention, a precise constant voltage control circuit is provided to supply electric power in a stable manner to each part, specifically, to the reference frequency oscillation circuit (500c), the receive frequency selecting part (500d) and the mixer part (500e).

In the data transmission, in order to modify the signal to have desired high frequency in the range of hundreds of MHz˜thousands of MHz, the reference frequency oscillation circuit (500i) generates basic oscillation frequency by using a reference oscillator X-Tal (crystal and TCX0) and the like. The basic frequency oscillated by using oscillation frequency from the reference frequency oscillation circuit (500i) shows little fluctuation. In connection with this, the transmission frequency selecting part (500j) helps to obtain constant oscillation frequency by automatically controlling the level of such fluctuation.

The digital signal (TTL level) inputted from the CPU or the controller is modulated to a type of voltage in analog level by a modulation encoder (not shown in the figure). In the mixer part (500k), the obtained constant basic frequency is mixed with the transmission data signal which is inputted from the modulation encoder (not shown) to form a wireless signal with low frequency.

For raising the frequency level of the wireless signal of transmission data mixed with low frequency to desired frequency level in the range of hundreds of MHz˜thousands of MHz, the signal is inputted in the frequency multiply part (500l). The frequency multiply part (500l) raises the low frequency of the inputted wireless signal to a desired frequency level by 2 multiply or 3 multiply. Since the wireless signal with a raised frequency level is weak, it is amplified by several tens of mW˜hundreds of mW, or by W unit, i.e. 1 dB˜tens of dB though the radio frequency amplification part (500m). The amplified wireless signal is emitted from the impedance matching part (500n) in its maximum matching output through the antenna. During the emission, each function of the intermediate frequency generation part (500f) and the demodulation part (500g) is temporarily held, however, the constant voltage control circuit supplies electric power as a constant voltage to each part of the circuit as same as the receive function.

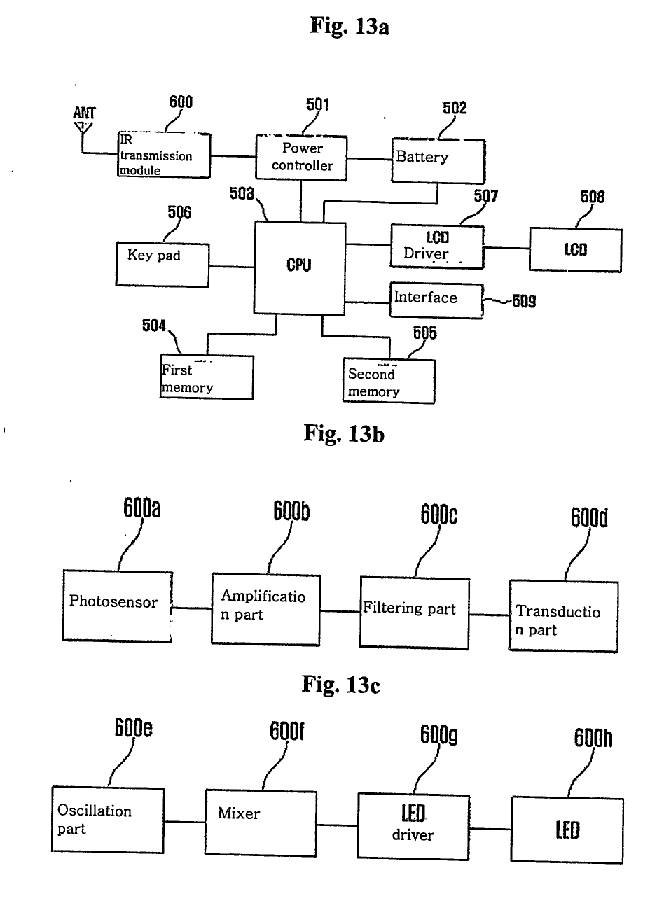

FIG. 13a is a block diagram which shows the control circuit of the wireless terminal adopting an infrared module according to Example 2 of the present invention. In the following description on the figure, the same reference numbers are used to explain the corresponding elements as in Example 1. With reference to FIG. 13a, it can be noticed that Example 2 is different from the foregoing Example 1 in that the infrared (IR) transmission module is used for data transmit-receive instead of the RF transmission module (600) of Example 1. Since other elements are the same as those of Example 1, detailed descriptions on these are omitted herein.

The infrared (IR) transmission module used in Example 2 is described in detail with making reference to FIGS. 13b and 13c as follows.

FIG. 13b is a scheme which roughly illustrates the wireless data receiving device of the wireless terminal adopting an infrared module according to the present invention. With reference to FIG. 13b, the infrared data receiving device of the wireless terminal according to the present invention comprises: a photosensor (600a) which receives an infrared control signal including a carrier, delivered from the outside; an amplification part (600b) which amplifies the infrared signal inputted from the photosensor (600a); a filtering part (600c) which removes the carrier element from the amplified signal; and a transduction part (600d) which transduces the filtered signal to TTL level of a general control or signal level.

FIG. 13c is a scheme which roughly illustrates the wireless data transmission device of the wireless terminal adopting an infrared module according to the present invention. With reference to FIG. 13c, the infrared data transmission device of the wireless terminal according to the present invention comprises: an oscillation part (600e) which generates a carrier pulse signal for the purpose of a long distance transmission responding to the signal which has been transduced to TTL level of the general control or signal level, then generates the oscillation pulse so that the TTL level signal can be mixed with the carrier signal; a mixer part (600f) in which the control signal and the carrier signal from the oscillation part (600e) are combined together and the combined signal is delivered to an LED driver (600g); the LED driver (600g) which controls electric voltage and current so that the infrared LED (600h) can be driven by the TTL signal including the carrier signal which is delivered from the mixer (600f); and an LED (600h) which is driven by the LED driver (600g).

With reference to FIGS. 13b and 13c, in data receiving, the infrared signal received from the outside which includes the specific number, item number, item colors, etc., is transduced to a certain amount of analog signal in the photosensor (600a) such as a photodiode. Since the received infrared signal is quite weak, it is inputted to the amplification part (600b) which amplifies the infrared signal for active operation.

The infrared signal inputted to the amplification part (600b) is amplified to in the order of 0V˜5V. Since the amplified signal includes a quite amount of noises and unnecessary light signals thereby being impossible to be changed to a digital signal in this state, the amplified infrared signal is inputted to the filtering part (band-pass filter) (600c) for accurate operation as well as removing noises.

The said filtering part (600c) is a circuit in which only a signal including the carrier oscillation frequency (38˜40 KHz) among the amplified input signals can be detected. The data signal which passed the filtering part (600c) is adjusted to a certain level (0V˜5V) of TTL level in the transduction part (600d) and outputted.

During this, a constant voltage power device which is not shown in the figure, supplies electric power in a stable manner, for preventing erroneous or unstable operation caused by voltage fluctuation.

In data transmission, the digital signal data inputted from the outside is inputted to a signal transduction circuit (not shown) which transduces TTL level to analog level, and is transduced to a data signal with a certain level (0V˜5V). The transduced data signal is inputted to the oscillation part (38˜40 KHz) (600e), then the signal with 38˜40 KHz by basic oscillation and the inputted data signal is mixed in the mixer part (600f) to output a signal which has been modulated to have 38˜40 KHz.

The modulated signal (data signal) is inputted to the LED driver (600g) for obtaining electric power to drive the infrared LED, then the inputted modulated signal is amplified by a transistor (TR) or other element, and the amplified modulated data is inputted to the infrared LED (600h). The infrared LED (600h) emits the infrared ray by utilizing the electric power which has been amplified in the LED driver (600g).

The constant voltage control circuit supplies electric power as a constant voltage to each part of the circuit as same as the receive function.

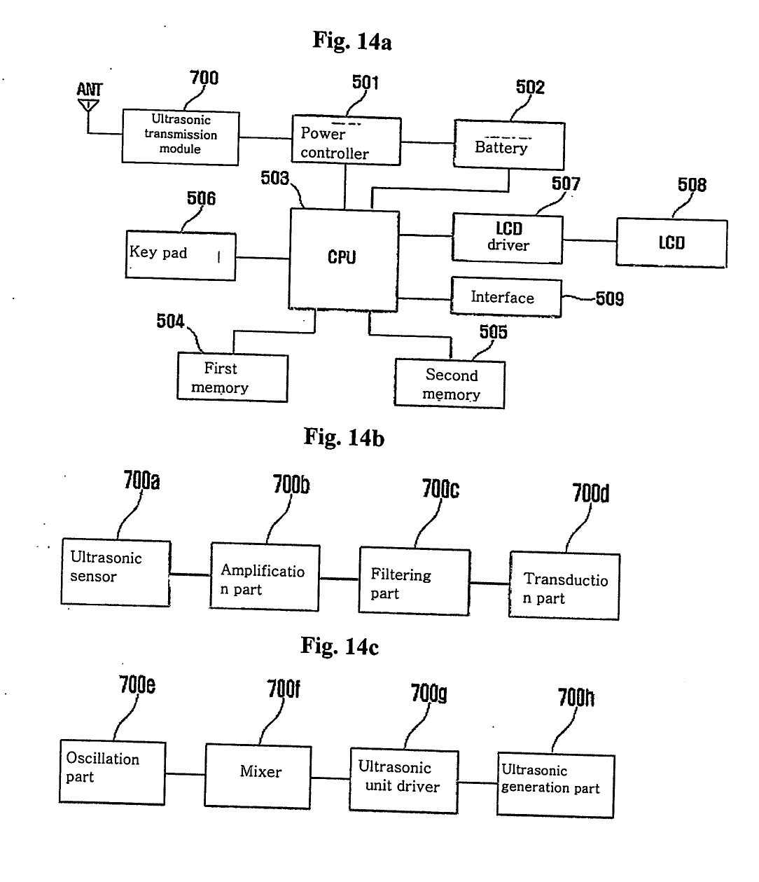

FIG. 14a is a block diagram which shows the control circuit of a wireless terminal adopting an ultrasonic module of Example 3 according to the present invention. In the following description on the figure, the same reference numbers are used to explain the corresponding elements as in Examples 1 and 2. With reference to FIG. 14a, it can be noticed that the present Example 3 is different from Examples 1 and 2 in that the ultrasonic transmission module (700) is used for data transmit-receive, instead of the RF transmission module of Example 1 or the IR transmission module of Example 2. Since other elements are the same as those of Examples 1 and 2, detailed descriptions on these are omitted herein.

The ultrasonic transmission module used in present Example 3 is described in detail with making reference to FIGS. 14b and 14c as follows.

FIG. 14b is a scheme which roughly illustrates the wireless data receiving device of the wireless terminal adopting the ultrasonic module according to the present invention. With reference to FIG. 14b, the ultrasonic data receiving device of the wireless terminal according to the invention comprises: an ultrasonic sensor (700a) which receives an ultrasonic control signal including a carrier, delivered from the outside; an amplification part (700b) which amplifies the ultrasonic signal inputted from the ultrasonic sensor (700a); a filtering part (700c) which removes the carrier element from the amplified signal; and a transduction part (700d) which transduces the filtered signal to TTL level of a general control or signal level.

FIG. 14c is a scheme which roughly illustrates the wireless data transmission device of the wireless terminal adopting the ultrasonic module according to the present invention. With reference to FIG. 14c, the ultrasonic transmission device of the wireless terminal according to the present invention comprises: an oscillation part (700e) which generates a carrier pulse signal for the purpose of a long distance transmission responding to the signal which is transduced to TTL level of the general control or signal level, then generates the oscillation pulse so that the TTL level signal can be mixed with the carrier signal; a mixer part (700f) in which the control signal and the carrier signal from said oscillation part (700e) is combined together and the combined signal is delivered to an ultrasonic oscillator; an ultrasonic unit driver (700g) which controls electric voltage and current so that the ultrasonic oscillator can be driven by the TTL signal including the carrier signal which is delivered from the mixer (700f); and an ultrasonic generation part (700h).

With reference to FIGS. 14b and 14c, the data transmission and data receiving are achieved in the same manner as described in the foregoing FIGS. 13b and 13c, except that ultrasonic wave is used instead of the infrared ray, thereby further detailed description on this is omitted herein.

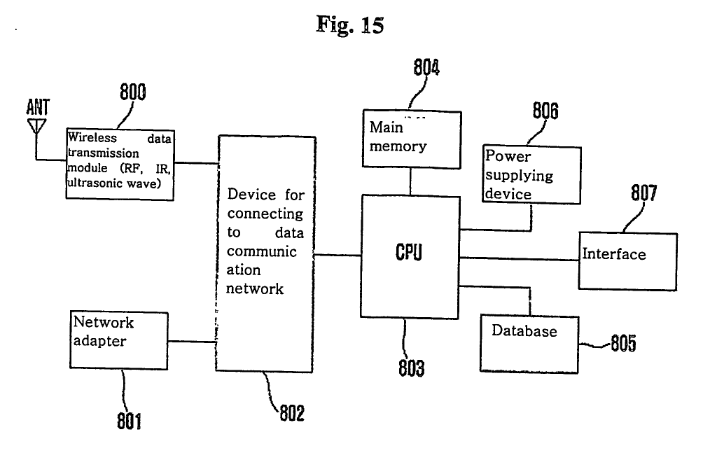

FIG. 15 is a block diagram which shows the control circuit of the electronic commercial transaction server according to the present invention. With reference to FIG. 15, the server of the present invention comprises: a wireless transmission module (800) which carries out the wireless data transmit-receive by using a method involving radio frequency (RF), infrared (IR) and ultrasonic wave; a network adapter (801) which can connect to the Internet through a cable/wire; a data communication network connecting device (802) which conducts interfacing between the wireless transmission module (800) and the network adapter (801) by being connected with them; a CPU (803) which processes the data inputted or outputted through the data communication network connecting device (802); a main memory (804) which stores a program required for system management and its specific code; a database (805) which stores the data processed by the CPU (803); a power supplying device (806) which supplies electric power to the whole system; and an interface (807) which supports connection of various devices or apparatuses which are connectable to the server.

Optionally, an element which can forcibly drive the wireless terminal system in a turned-off state to run, may be added as in the construction of the wireless terminal. Specifically, a power controller (not shown in the figure) can be further provided between the wireless transmission module (800) and the power supplying device (806) to forcibly drive the server in a turned-off state to run.

A procedure in which the server obtains data from other wireless terminal through communication with them is as same as described in the above “1. procedure of obtaining data of the wireless terminal B at the wireless terminal A” and “2. procedure of obtaining data of the wireless terminal A at the wireless terminal B”, therefore detailed description on this is omitted herein for fear of redundancy.

While the present invention has been described with reference to the specific Examples thereof, without being limited to these, it should be understood by those skilled in the art that various changes and modifications may be made without departing from the spirit and scope of the invention, and all such changes and modifications are within the scope of the present invention.

### INDUSTRIAL APPLICABILITY

As it has been described so far, according to the present invention, a member who had already purchased a certain item is served as a kind of an advertising model in everyday life and can obtain profits in reward of sharing his/her information as an indirect advertising model.

In the light of a new purchaser, when he/she is fascinated with items which are worn by other person in everyday life, or items which are represented on a home shopping mall of the Internet regardless of being purchased or non-purchased by the owner of the shopping mall, for example clothes, accessory or valuables, etc., and wishes to purchase one of those or wishes to imitate the member's fashion trend, the new purchaser can easily obtain the item or fashion information from the member's wired or wireless terminal and place an order for purchase the item. For example, when a user wishes to imitate fashion trend of a certain person who has a good sense in fashion, the user can purchase the same clothes or accessories with those of the certain person on online shopping mall, without browsing various shops on foot to search for those items, even the purchaser can select the same item of different materials, colors or even designs. The user can obtain a bundle of purchase information through the wired or wireless terminal.

In the light of the seller, the maximum advertisement effect with low cost can be obtained since all the members and purchasers serve as an advertising model. The seller may gives no or small amount of allotment of sales profit to a member who only made a search for a certain item without purchasing the item.

All in all, according to the invention, a purchaser can serve as an advertising person as well as a seller, and the purchased item can be registered as a sales item of the purchaser by providing a home shopping mall owned by the purchaser, i.e. a novel concept that a purchaser can advertise the purchased item while using it, and also make profits by selling the same kind of the item, is provided by the present invention, thereby providing profits to a purchaser along with a seller.

What is claimed is:

1. An electronic commerce system characterized by comprising a wireless terminal A and another wireless terminal B each containing item information; and a wireless transmission module which is provided to transmit a data demanding signal from the wireless terminal A to B or from the wireless terminal B to A and transmit the requested data responsive to the demanding signal, wherein the sales entity is decided to be a wireless terminal which provides stored information as a processed data format including its own wireless terminal specific code, the other party's wireless terminal specific code and item information, by transmitting said processed data to the other party responding to said data demanding signal received from the other party.

2. A electronic commerce system according to the present invention, characterized in that an electronic commercial transaction is performed by collecting item information from a member, searching the item, placing an order for the item, and allotting a certain portion of the payment for the item to the member, is characterized by comprising:
a tag which includes information on the item specific code and is attached to the corresponding item for identification;
a code reader which can read in the item specific code included in the tag;
a memory device which stores the terminal specific number, the item specific code read in by the code reader, and information on the item, the member who purchased the item and other items which was purchased and registered by the above member;
a plurality of wired or wireless network terminals equipped with a data transmit-receive device which can directly transmit the data including the terminal specific number stored in the memory device to other terminal in case of searching, and can connect to the electronic commercial transaction server, in case of placing an order, through the wired or wireless communication network;
a database which stores the terminal specific number, the item specific code, a photographed image of the item, and information on the item, the member who had already purchased the item and other items which were purchased and registered by the same member; and
an electronic commercial transaction server in which order information is inputted from the wired or wireless terminal according to the decision of the new purchaser (a second member or a third member), the order is placed by transferring the order information including the terminal specific number, the photographed image of the item and the item specific code to a supplier, the terminal specific number, the item information and item specific code thereof are stored and registered to said database with the purchaser information which was inputted by the purchaser him/herself, payment is performed through an associated financial institution terminal, and when the payment is completed, a certain portion of the payment is allotted to the (first) member in proportion to the degree of contribution,
wherein the each terminal specific number is registered to the electronic commercial transaction server along with the information on each member,
wherein the second terminal of the new purchaser (the second member) or the third terminal among the plurality of wired or wireless terminals can search for said information, which is stored in the memory device of a first terminal of the first member, through the data transmit-receive device, save said information into the memory device of the second terminal or the third terminal, then order the item with transmitting said information to the electronic commercial transaction server.

3. The electronic commerce system according to claim 2, characterized in that, even if the power of the first terminal is turned off, the second terminal can turn on the power of the data transmit-receive device (451) of the first terminal in a stand-by state, and receive the information contained in the first terminal,
and vice versa, even if the power of the second terminal is turned off, the first terminal can turn on the power of the data transmit-receive device (452) of the second terminal and receive the information contained in the second terminal.

4. The electronic commerce system according to claim 1 or 3, characterized in that each of the wireless terminals A and B, and the first and the second terminal is a wireless terminal, wherein the wireless terminal comprises: a wireless transmission module which receives the demanded data transmitted from other wireless terminal and also transmits data contained in its own wireless terminal;
a power controller which can maintain electric power in a stand-by state when electric power of the wireless terminal is turned out by its user, and generate power control signals for driving the wireless terminal;
a battery which supplies electric power to the wireless terminal;
a CPU which is supplied with electric power from the battery and conducts the whole system control, including data transmit-receive and processing, responding to the data demand from other wireless terminal;
a first memory which stores the data transmitted through the above wireless transmission module as well as provides the stored data;
a second memory in which a wireless terminal program including information of the above wireless terminal is stored;
a key pad which supports the operation by the user; and
a display which carries out the output of data which has been transmitted or received and the operation by the user.

5. The electronic commerce system according to claim 4, characterized in that the wireless transmission module includes a radio frequency (RF) data transmission device and RF data receiving device.

6. The electronic commerce system according to claim 5, characterized in that the RF data receiving device comprises:
an impedance matching part wherein the impedances between the antenna (ANT) and the wireless circuit are matched;
a radio frequency (RF) amplifying part wherein radio frequency amplification and waveform shaping are conducted in order to demodulate FSK data inputted through the antenna (ANT);
a reference frequency oscillation circuit which generates reference frequency;
a receive frequency selecting part wherein receive frequency is determined by using the oscillated frequency from the above reference frequency oscillation circuit;
a mixer part wherein intermediate frequency is formed by using the determined receive frequency and the received frequency;
an intermediate frequency generation part wherein the intermediate frequency is generated from the inputted wave form by using the frequency which has been determined at the above receive frequency selecting part, in order to receive accurate data; and
a demodulation part wherein the demodulated FSK signal is modulated to TTL level in order to use the FSK signal as a general control signal.

7. The electronic commerce system according to claim 5, characterized in that the RF data transmission device comprises:
a modulation part for modulating the general control signal in TTL level to a FSK signal;
a reference frequency oscillation circuit which generates reference frequency;
a transmission frequency selecting part wherein transmission frequency is determined by using the oscillated frequency from the above reference frequency oscillation circuit;
a mixer part wherein the frequency to be transmitted is formed by using the transmission frequency which is determined at the above transmission frequency selecting par;
a frequency multiply part for conducting frequency multiply in order to form a frequency for transmission by using the frequencies from the above reference frequency oscillation circuit and the above transmission frequency selecting part;
a radio frequency amplification part wherein amplification is achieved by compounding a signal in TTL level with the above multiplied frequency; and
an impedance matching part in which the impedances between the antenna (ANT) and the wireless circuit are matched.

8. The electronic commerce system according to claim 4, characterized in that the wireless transmission module is an infrared data transmit-receive device.

9. The electronic commerce system according to claim 8, characterized in that the infrared data receiving device comprises: a photosensor which receives an infrared control signal including a carrier, delivered from the outside; an amplification part which amplifies the infrared signal inputted from the photosensor; a filtering part which removes the carrier element from the amplified signal; and a transduction part which transduces the filtered signal to TTL level of a general control or signal level, and
the infrared data transmission device comprises: an oscillation part which generates a carrier pulse signal for the purpose of a long distance transmission responding to the signal which has been transduced to TTL level of the general control or signal level, then generates the oscillation pulse so that the TTL level signal can be mixed with the carrier signal; a mixer part in which the control signal and the carrier signal from the oscillation part are combined together and the combined signal is delivered to an LED driver; the LED driver which controls electric voltage and current so that the infrared LED can be driven by the TTL signal including the carrier signal which is delivered from the mixer; and an LED which is driven by the LED driver.

10. The electronic commerce system according to claim 4, characterized in that the wireless transmission module is an ultrasonic data transmit-receive device.

11. The electronic commerce system according to claim 10, characterized in that the ultrasonic data receiving device comprises: an ultrasonic sensor which receives an ultrasonic control signal including a carrier, delivered from the outside; an amplification part which amplifies the ultrasonic signal inputted from the ultrasonic sensor; a filtering part which removes the carrier element from the amplified signal; and a transduction part which transduces the filtered signal to TTL level of a general control or signal level, and
the ultrasonic transmission device comprises: an oscillation part which generates a carrier pulse signal for the purpose of a long distance transmission responding to the signal which is transduced to TTL level of the general control or signal level, then generates the oscillation pulse so that the TTL level signal can be mixed with the carrier signal; a mixer part in which the control signal and the carrier signal from the oscillation part is combined together and the combined signal is delivered to an ultrasonic oscillator; an ultrasonic unit driver which controls electric voltage and current so that the ultrasonic oscillator can be driven by the TTL signal including the carrier signal which is delivered from the mixer; and an ultrasonic generation part.

12. The electronic commerce system according to claim 4, characterized by further comprising a server which communicates with the wireless terminal, wherein the server comprises: a wireless transmission module which carries out the wireless data transmit-receive by using a method involving radio frequency (RF), infrared (IR) and ultrasonic wave; a network adapter which can connect to the Internet through a cable/wire; a data communication network connecting device which conducts interfacing between the wireless transmission module and the network adapter by being connected with them; a CPU which processes the data inputted or outputted through the data communication network connecting device; a main memory which stores a program required for system management and its specific code; a database which stores the data processed by the CPU; and a power supplying device which supplies electric power to the whole system.

13. The electronic commerce system according to claim 12, characterized in that the server system further comprises a power controller which is provided between the wireless transmission module and the power supplying device to forcibly drive the server in a turned-off state to operate.

14. The electronic commerce system according to claim 2, characterized in that the code reader can read one selected from tag, bar code, integrated circuit chip in which the item specific code is contained.

15. The electronic commerce system according to claim 2, characterized in that the information that the terminal of the second member receives from the terminal of the first member includes 1) the terminal specific number of the first member, 2) photographed image of the item which was purchased by the first member and 3) the item specific code of the item which was purchased by the first member.

16. The electronic commerce system according to claim 2, characterized in that the plurality of terminals further includes a digital camera, which makes possible to input a picture of the item and information on the item coordination made by the member, by taking a picture of the appearance of the member with the coordinated item.

17. The electronic commerce system according to claim 2, characterized in that the information being transmitted from the second terminal to the third terminal is limited to the purchased item information of the second terminal user among the information contained in the second terminal, considering the memory capacity.

18. The electronic commerce system according to claim 2, characterized in that the electronic commercial transaction server allots a certain portion of the payment to the plurality of members in different ratio.

19. The electronic commerce system according to claim 2, characterized in that the third terminal of another purchaser (the third member) among the plurality of wired or wireless terminals can search the information from the second terminal of the second member through the data transmit-receive device, and save the information into the memory device, then place an order for the item, provided that there is no information that the second member purchased the item among the information received from the second terminal, the electronic commercial transaction server does not allot a certain portion of the payment to the second member.

20. The electronic commerce system according to claim 2, characterized in that the third terminal of another purchaser (the third member) among the plurality of wired or wireless terminals can search the information including the terminal specific code from the second terminal of the second member through the data transmit-receive device, and save the information into the memory device, then place an order for the item, provided that there is no information that the second member purchased the item in the information received from the second terminal, the electronic commercial transaction server allots a certain portion of the payment, which is smaller than that of the first member, to the second member.

21. The electronic commerce system according to claim 2, characterized in that the third terminal of another purchaser (the third member) among the plurality of wired or wireless terminals can search the information including the terminal specific code from the second terminal of the second member through the data transmit-receive device, and save the information into the memory device, provided that there is no information that the second member purchased the item in the information received from the second terminal, the third terminal cannot place an order for the item.

22. The electronic commerce system according to claim 2, characterized in that when the tag is in the form of a label where a series of numbers is represented as the item specific code, the purchaser can search for the item by inputting the series of numbers into the wired or wireless terminal.

23. The electronic commerce system according to claim 2, characterized in that when the tag is in the form of a label where a bar code is represented as the item specific code, then the code reader is for reading in the bar code, and the purchaser can connect the reader to said wired or wireless terminal and transmit the item specific code read in by the bar code reader to said electronic commercial transaction server and/or to other wired or wireless terminal.

24. The electronic commerce system according to claim 2, characterized in that when the tag is in the form of an integrated circuit chip storing the item specific code, then the integrated circuit chip is installed in the certain position of the item and the code reader is a chip reader for reading in the item specific code stored in the integrated circuit chip, the purchaser can connect the chip reader to said wired or wireless terminal and transmit the item specific code read in by the chip reader to said electronic commercial transaction server and/or to other wired or wireless terminal.

25. A method of electronic commerce characterized by using a wireless transmission module which is provided to transmit a data demanding signal from the wireless terminal of the other party as well as transmit the requested data responsive to the demanding signal, a wireless terminal A and another wireless terminal B each containing item information and having the wireless transmission module, wherein the sales entity is decided to be a wireless terminal which provides stored information as a processed data format including its own wireless terminal specific code, the other party's wireless terminal specific code and item information, by transmitting said processed data to the other party responding to said data demanding signal received from the other party.

26. A method of electronic commerce in which a commercial transaction is performed by collecting item information from a member, searching the item, placing an order for the item, and allotting a certain portion of the payment for the item to the member, is characterized by comprising:
a first step of first purchase, in which a photographed image and an item specific code given to the corresponding item and information concerning the item are read in by a code reader, then further saved to a memory device of the wired or wireless terminal which contains information on the first member who first purchased the item, terminal specific number and other items which were purchased by said member;
a second step of data saving by a second member, in which a new purchaser (the second member) who wishes to search and/or purchase the same item purchased by the first member, receives the terminal specific number, the item specific code, the photographed image of the item, and information concerning the item, the first member and other items which were purchased by the first member from the first terminal of the first member, through a data transmit-receive device of a second terminal of the second member or inputs a picture of the item which is photographed by the second member and the item specific code, and save the received or inputted information in the memory device of the second terminal, and/or connects to the electronic commercial transaction server through the wired or wireless network to transmit the order information;
a third step of data saving and order by a third member, in which other new purchaser (the third member) who wishes to search the terminal specific number of the first or the second member and search and/or purchase the same item which was purchased by the first or second member, receives the terminal specific number, the item specific code, the image of the item, and the information concerning the item, the first and second member and other items which were purchased by the first or second member from the second terminal of the second member, through a data transmit-receive device of the third terminal of the third member, and save the information in the memory device of the third terminal, then connects to the electronic commercial transaction server through the wired or wireless network to transmit the order information;
a fourth step of taking the order, in which the electronic commercial transaction server receives the order information including the terminal specific number from the third terminal of the third member to transmit again said order information including the item specific code to a supplier's terminal, while saving information concerning the item including the terminal specific number, the item specific code and information on said members into its database; and
a fifth step of allotting a certain portion of the payment for the item, in which when the purchaser completes the payment for the item, said electronic commercial transaction server allots a certain portion of the payment to the plurality of members as a reward, in proportion to the degree of contribution.

27. The method of electronic commerce according to the claim 26, characterized in that the third terminal of the third member can search the information in the second terminal of the purchaser (the second member) through the data transmit-receive device of the third terminal, save the information to its memory device, and place an order for the item, while in the fifth step, if there is no information that the second member purchased the item in the database, the electronic commercial transaction server does not to allot a certain portion of the payment to said second member.

28. The method of electronic commerce according to the claim 26, characterized in that the third terminal of the third member can search the information in the second terminal of the purchaser (the second member) through the data transmit-receive device of the third terminal, save the information to its memory device, and place an order for the item, while in the fifth step, if there is no information that the second member purchased the item in the database, the electronic commercial transaction server allots a certain portion of the payment, which is smaller than that of the first member, to the second member.

29. The method of electronic commerce according to the claim 26, characterized in that the third terminal of the third member can search the information in the second terminal of the purchaser (the second member) through the data transmit-receive device of the third terminal, save the information to its memory device, and place an order for the item, while in the third step, if there is no information that the second member purchased the item in the database or the second terminal of the second member, the third terminal cannot place an order for the item.

30. The method of electronic commerce according to any one of claims 26 to 29, characterized by a data transmit-receive method between a wireless terminal A which is a data demander and another wireless terminal B which is a data provider in said first terminal, the second terminal and the third terminal, comprising the steps of:
a first step of positioning the wireless terminal A and the wireless terminal B within the range being capable of data transmit-receive;
a second step in which the wireless terminal A transmits its terminal specific code and a data demanding signal to the wireless terminal B;
a third step in which the wireless terminal B reads out the contained data, responding to the received terminal specific code and data demanding signal from the wireless terminal A;
a fourth step in which a data format which defines the demanding entity is processed by using the terminal specific codes of the wireless terminals A and B with the data read out from the wireless terminal B;
a fifth step in which the processed data is transmitted from the wireless terminal B to the wireless terminal A; and
a sixth step in which the wireless terminal A receives the processed data, and saves and displays it.

31. The method of electronic commerce according to claim 30, characterized by, when there is a plurality of wireless terminals around the wireless terminal which contains demanded data, approaching a wireless terminal which demands data, most near to the wireless terminal which contains demand data.

32. The method of electronic commerce according to claim 30, characterized in that, even though the wireless terminal system B is in a turned-off state (OFF), it is forcibly turned on by controlling the battery of the wireless terminal B through a power controller of the wireless terminal B, using the terminal specific code of the wireless terminal A or the data demanding signal from the wireless terminal A as a driving signal.

33. The method of electronic commerce according to claim 30, characterized in that the processed data has a data format comprised of “wireless terminal A+wireless terminal B+demanded data”.

34. The method of electronic commerce according to claim 33, characterized in that the demanded data includes the seller's address, and characteristic features, color and size of the corresponding item.

35. The method of electronic commerce according to claim 34, characterized by further comprising a step of providing the processed data format to the seller of the item so that mileage or points of the user of the wireless terminal B can be accumulated.

36. The method of electronic commerce according to claim 35, characterized in that the wireless terminal B is a server which stores and manages data concerning item sales.

37. The method of electronic commerce according to claim 30, characterized in that, in transmission of the terminal specific code and data demanding signal from the wireless terminal A, when a plurality of other wireless terminals exists other than the wireless terminal B, the method further comprises the steps of:
a step of transmitting the terminal specific code and the data demanding signal of the wireless terminal A to the wireless terminals including the wireless terminal B;
a step of storing the processed data from the wireless terminal B which is positioned most near to the terminal A as a demanded data, while storing the processed data from other wireless terminals as a temporary data in the wireless terminal A;
a step of deleting the terminal specific code and the data demanding signal of the wireless terminal A from other wireless terminals; and
a step of deleting the temporary data from the wireless terminal A after a determined period of time.

38. The method of electronic commerce according to claim 30, characterized in that in data transmit-receive between the wireless terminals A and B, a step where the inputted signal is determined to be a illegal electric wave, noise or normal signal is conducted in advance.
